(19) United States
(12) Patent Application Publication
(10) Pub. No.: US 2024/0232249 A9
(43) Pub. Date: Jul. 11, 2024

(54) Machine Learning System and Method for Media Tagging

(71) Applicant: Katch Entertainment Inc., Woodside, CA (US)

(72) Inventors: Arthur Coleman, Carmel Valley, CA (US); Nolan Gasser, Petaluma, CA (US); Ray Kraus, Rochester, NY (US); Michael Bowen, Berkeley, CA (US); Oscar Barrios, Panama City (PA); Baishnavi Bihare, Columbus, OH (US); Jimmy Figueroa, San Jose (CR); Roberto Hernandez, Tegucigalpa (HN); Noah Nodolski, Palm Beach Gardens, FL (US); Briana Robertson, Redmond, WA (US); Kristy Strouse, Cambridge, ME (US)

(21) Appl. No.: 18/546,138

(22) PCT Filed: Jul. 1, 2022
(86) PCT No.: PCT/US2022/035978

§ 371 Date: Aug. 11, 2023

Related U.S. Application Data
(60) Provisional application No. 63/217,960, filed on Jul. 2, 2021.

(51) Int. Cl. G06F 16/41; G06F 16/483

(52) U.S. Cl. CPC G06F 16/41; G06F 16/483

(57) ABSTRACT

A method and system for coding of a media “genome” employs machine learning models for social tagging of media titles. A media genome is a detailed description of the intrinsic elements that make up a piece of content; it is a comprehensive taxonomy that considers every impactful dimension of a film, TV episode, video short, video game, or other media title. The genome may be used by filmmakers to better understand their content, as well as that of competitors. It may also be used by entertainment marketers to better target their marketing budget for specific audiences, and by brands to determine which televisions programs and films they wish to advertise around or sponsor placements in.

### CROSS-REFERENCE TO RELATED APPLICATIONS

This application claims the benefit of U.S. provisional patent application No. 63/217,960, filed on Jul. 2, 2021. Such application is incorporated herein by reference in its entirety.

### BACKGROUND

The system, method and apparatus presented herein relates to the field of understanding and tagging the intrinsic elements of media at a fine-grained level so that content creators, owners, and marketers can deeply understand how to best target their content to the tastes of specific audiences.

The data science community has for years attempted to automate tagging of media titles through the creative use of natural language processing and image processing applied to large amounts of data scraped, filtered, and manipulated from the web. In the media industry, this data is referred to as “metadata”, as it describes extrinsic features of media titles versus features that are intrinsic to the content itself. Examples of metadata run from elements as basic as the release date of a title, its cast, its box-office numbers, or its genre to complex elements like word associations that consumers make with the media title in online reviews. The goals of most of this work has been to provide more detailed insight into each specific media title in order to improve the recommendations made to consumers for what they should watch. While streaming services like Netflix or Amazon Prime have behavioral data on what their customers watch, and so can make recommendations based on techniques like collaborative filtering, these approaches don't provide any insight into why and what causes consumers to watch the media titles they do. The hope has been that attaching metadata to the data sets used for modeling recommendations would provide some insight and improve the quality of recommendations.

Sadly, the results show only marginal improvements at best. In “Tuning Metadata for better movie content-based recommendation systems”, published by Paula Viana in April 2014, the author found that “one of the conclusions that can be drawn from the results presented is that using the information on directors rather than the, commonly considered relevant, genre and list of actors, enables a better performance of content-based algorithms.” In addition, the author found that “the impact on using a more complete set of metadata (All: Actors+Directors+Genre) does not contribute to decrease MAE [mean average error] and may only slightly contribute to increase the precision.” In the case of the one type of metadata that worked—directors—the reduction in MAE decreased by about 12% in the best case tested, but precision of the prediction (the ability of the model to identify the relevant data points) also decreased. The author concluded that “although the collaborative algorithm usually performs better, improvements can be achieved in the content-based approach by using the adequate metadata information, making the results quite similar.” “Quite similar” means, in this case, that the improvements were marginal at best. And for that reason, the media industry continues to seek other forms of data that can provide deeper insights into consumers tastes and preferences for media—getting deeper into the “why” and the causes for consumers' behaviors around media titles.

Even with the latest deep learning techniques, no algorithm can tell if a movie or series has “a healthy father daughter relationship” or “a use of montage”, for example. But hand coding a parameter base of any size, which requires watching the media and then entering values for each of thousands of parameters, is inherently time consuming when a typical movie runs about two hours. Even where some number of parameters may be automated through NLP (natural language processing) or other data science techniques, someone still has to watch the entire media title to fill in those that cannot be automated. There are already over 1,000,000 movie titles in existence and about 3,000,000 series episodes. Each year 7,000 new movies and 50,000 new series episodes are added to this base. Tagging all this content one time would take approximately 1,000 man-years, and often there is a need for multiple codings of media titles in order to ensure statistical validity. This requirement has to do with variances that occur in human perceptions of content features. For example, one person may score a lead character in a specific film as a 3 on the parameter “Humble-to-Arrogant”, while someone else equally knowledgeable may score that character's parameter as a 4. Multiple codings provide a basis on which to determine which perception is closer to the view of the overall universe of viewers.

There is increasing urgency in the media industry to better understand the motivations behind consumer behavior. The major reason for this is a disruptive change in the nature of competition since the arrival of streaming services like Netflix, and the shift to streaming services creating their own content. The “old model” for Hollywood involved “gut-based” decision-making. Executives believed they could tell based on their experience in the industry and instincts what would or would not do well. The top executives in the industry also worked to develop the best networks of writers, producers, directors, and actors at their fingertips so that they could leverage those assets to a competitive advantage. They also had the best network of distribution partners to get movies into theaters. But to get movies into theaters worldwide was expensive and also risky. Studios that couldn't get ‘butts in seats” would ultimately lose precedence and access to movie screens and cineplexes. The need was thus to make blockbusters that yielded high viewership across a worldwide audience. Blockbusters take lots of money, and also tend to have a high failure rate. At the same time, the release window—the time between a movie's theatrical release and its release onto DVD—was shrinking, thus increasing the likelihood that production and marketing costs would not be recouped. Between 2000 and 2019, the period for studios to recoup costs at the box office dropped from 180 days to 92 days. Given these factors, studios looked to reduce their risk of losses. There were two key strategies: (1) get top-name actors who had followings or (2) create a franchise/formula, such as James Bond, that drew viewers back to theaters independent of the specific movie content. The control points were thus access to capital, access to talent, and access to distribution.

With the arrival of the commercial Internet, the cost of processing power has dropped almost to zero, the amount of bandwidth is increasing exponentially, and the cost of that bandwidth also has dropped to almost nothing. These new technologies changed not only approaches to distribution but the entire economics of the industry. First, media titles could now be streamed directly to desktop and mobile devices, making it exceedingly easy for consumers to consume content. Second, and most importantly, every action that a consumer took around these media titles—search terms put in, items clicked on but not viewed, media titles played, how often and how long sessions were—was now captured and available for analysis. As a result, consumers could be split into consumption segments based on the wealth of data and content produced/acquired for those specific, smaller, but well-defined audiences.

The result was an opportunity for a different kind of content: lower budget, more targeted to smaller audiences, with a higher likelihood of success, sold through monthly subscriptions and an annual recurring revenue model. And the way content was paid for also changed. First, it made great sense to license existing content that was historically not easily available online from the existing content producers/studios to fill slates and pay on a per-view or fixed monthly or annual fee basis. Second, instead of purveyors of new content being paid a percentage of net revenue from a media title, Netflix now established a cost+model, where they paid production costs plus a percentage for profit, putting all the production-cost risk on the producer. Fixed production costs fit well with a fixed-revenue, ARR (annual recurring revenue) driven model.

The alignment of all these factors and the growing share of viewing occurring on the Internet produced high growth rates for streaming services at the expense of theater-based viewing. The control points for this part of the industry now became access to data and top-notch data science to recommend content to consumers, access to a wide variety of content producers willing to make content on smaller budgets, and maintenance of a loyal subscription base with low attrition rates.

Media producers had watched the old-line record companies be disintermediated first by digital music players like iPods and then by direct-to-streaming music services like Pandora and Spotify. They had no intention of making the same mistakes. And so, since 2010, three years after Netflix was launched, the bigger studios and production companies have either purchased or started their own streaming services. Examples include Hulu (owned by Disney/Comcast); Peacock (owned by NBC Universal); HBO Max (owned by WarnerMedia; and Disney Plus (owned by Disney).

At the same time, large media production companies stopped licensing their content libraries to other services so that they could lock in their audiences solely onto their platforms. The result is that streaming has now become more like broadcast, linear television, where the major networks also produce their own content at great expense. In 2021, the top streaming services spent $120.5 B on content production, with 72% of that being spent by the top five all of whom are subscription-based video-on-demand (SVOD) services.

The implications of this new landscape are significant, because the risk profile of the business has now changed. More of each streaming service's slate must derive from content made specifically for that service. This means that each service needs an even better understanding of their customers' tastes in order to size their audiences correctly and acquire new content at the correct price. Behavioral data isn't good enough anymore, and metadata doesn't add enough value. There is a need to understand the intrinsic factors that drive demand for content at a deep level.

References mentioned in this background section are not admitted to be prior art with respect to the present invention.

### SUMMARY

The present invention is directed to a system and method for the coding of a media “genome” using machine learning models that facilitate human-mediated social tagging of media titles. A media genome enables a detailed description of the intrinsic elements that make up a piece of content, just as DNA provides in biology. It is a comprehensive taxonomy that considers every impactful dimension of a media property, such as a film, TV episode, video short, video games, etc. The database that stores the genome can consist of any number of “genes,” and has the ability to be updated as needed for improved processing, or equally important for the evolving nature of content, social norms, and consumer tastes. In a particular embodiment of the present invention, there are approximately 1,850 genes identified to describe any given single-episode title like a movie or YouTube video, and approximately 2,500 genes identified to describe any given series. The genes are organized into several large-scale categories that define the combined identity and experience—including context, characters, plot, script, visuals, music, mood, aesthetics and others. Each category is then divided into various sub-categories and sub-sub-categories wherein the individual, nuanced “genes” reside. The genome thus enables the creation of a huge database of “genomic imprints” of media titles of all stripes and profiles. These imprints in turn allow content experts to define both the overall identity of each media title and also those specific “genomic” elements (such as an explicit character type, plot theme, setting element, lighting technique, or mood) that make the title unique, and that help explain why it may or may not resonate with a given consumer.

In certain embodiments, the present invention may consist of the following elements:
(1) A database that is a physical instantiation of a taxonomy of genes (parameters) describing a media genome (a full set of parameters describing the media);
(2) a structured platform that facilitates human watching and coding of media titles as members of a community of coders who share common tools, training, and concepts around media titles;
(3) an image processing platform in which a series of computers running image processing and text processing algorithms continuously “watch” media titles and extract some easily-reduced subset of an entire genome for each title;
(4) algorithms to allow statistical processing of episodes into seasons and into series genes;
(5) algorithms to allow statistical processing of movies and series into franchises;
(6) a set of validation rules that are used to ensure tagging entries are done correctly;
(7) a structured platform for performing quality-control checks on the codings, including algorithms to rate and select the best representation of a piece of media from any number of codings of that title;
(8) an application programming interface (API) based and microservices-based computing platform and architecture for delivery of these services; and
(9) a training platform and a set of training processes to ensure that all media titles are coded in a similar fashion.

These and other features, objects and advantages of the present invention will become better understood from a consideration of the following detailed description of the preferred embodiments and appended claims in conjunction with the drawings as described following:

### DRAWINGS

FIG. 1 is a diagram of a genomic database data structure according to an embodiment of the present invention.

FIG. 2 is an example of pseudocode for gene value aggregation from episode to season according to an embodiment of the present invention.

FIG. 3 is an overall architectural view of the system according to an embodiment of the present invention.

FIG. 4 is a continuation of the overall architectural view of the system according to an embodiment of the present invention continued from FIG. 3.

FIG. 5 is a diagram of the architecture of the genomic and metadata database according to an embodiment of the present invention.

FIG. 6 is a diagram of the architecture of the tenant and user database according to an embodiment of the present invention.

FIG. 7 is a diagram of the architecture of the script database according to an embodiment of the present invention.

FIG. 8 is a diagram of the architecture of the application servers according to an embodiment of the present invention.

FIG. 9 is a diagram of the architecture of the identity and authorization management service (IAMs) according to an embodiment of the present invention.

FIG. 10 is a user screen for interacting with the user and systems management tools according to an embodiment of the present invention.

FIG. 11 is a diagram of the architecture of the internationalization service according to an embodiment of the present invention.

FIG. 12 is a user screen for media selection within the media coding tool according to an embodiment of the present invention.

FIG. 13 is a user screen for coding within the media coding tool according to an embodiment of the present invention.

FIG. 14 is a user screen for documentation within the media coding tool according to an embodiment of the present invention.

FIG. 15 is a user screen for entering notes within the media coding tool according to an embodiment of the present invention.

FIG. 16 is a user screen for viewing user history within the media coding tool according to an embodiment of the present invention.

FIG. 17 is a diagram of the architecture for an image processing platform according to an embodiment of the present invention.

FIG. 18 is process flow diagram for a QA process for codings at the QA platform according to an embodiment of the present invention.

FIG. 19 is a user screen for coding review within the QA platform according to an embodiment of the present invention.

FIG. 20 is a user screen for providing coding history functions within the QA platform according to an embodiment of the present invention.

FIG. 21 is a user screen for a training platform within the collaboration subsystem according to an embodiment of the present invention.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

### The Genomic Database and Its Taxonomy

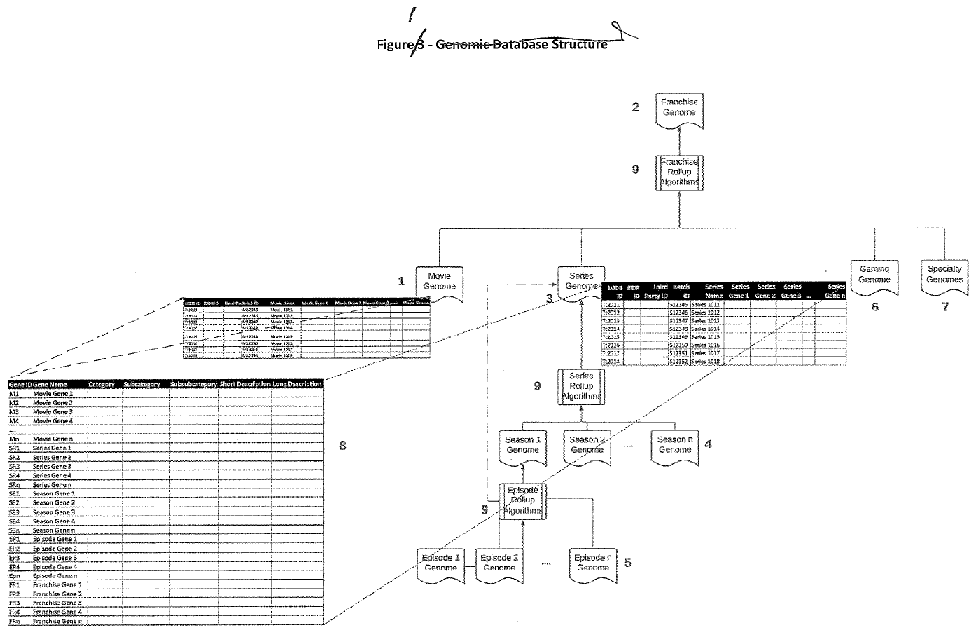

Referring now to FIG. 1, the basic structure of the genomic database according to an embodiment of the present invention may be described. The database consists of a large number of “genes” (parameters) that together make up the genome (full list of applicable parameters) for a particular media property. The genomic database is a comprehensive taxonomy that considers every impactful dimension of a media property such as a film, TV episode, video short, video game, etc. The database can consist of any number of genes, and has the ability to be updated as needed for improved processing, or equally important for the evolving nature of content, social norms, and consumer tastes.

Genomes and their representation in a database and software are unique to each subject area. Even within this subject area, however, there are multiple genomic representations needed to completely describe the universe of media titles. The genome according to an embodiment of the present invention has the elements described as follows.

Movie genome 1 includes individual films, stand-alone YouTube videos, and even individual advertisements that can be handled as separate entities, with a single record needed per film, video or advertisement. In an embodiment, the film-related elements are divided into six categories, 38 subcategories and 157 sub-subcategories. These segmentations are not fixed; their number and relationship can change as the nature of the genes or their use cases evolve. This invention, in certain embodiments, instantiates the generalized notion of a genome and its category hierarchy, not a specific implementation as may be presented in various alternative embodiments.

Franchise genome 2 addresses the fact that, in some cases, single titles are part of a larger franchise, e.g., James Bond or the Marvel Comic Universe (MCU). In these cases, the single titles need to be aggregated into one overall genome as well as summarized with franchise-level tags. This process becomes even more complex as some individual films are part of multiple franchises. For example, a Spiderman movie is part of the Spiderman franchise as well as the MCU. To summarize the franchise, coders need to score a separate survey where over 200 additional genes are divided into 101 sub-subcategories—the categories and subcategories are the same as single title films.

With respect to series genome 3, there are in this particular embodiment three kinds of series. Episodic series differ from other types because the episodes do not flow in an obvious order. Each episode can, and usually does, have its own self-contained storyline, independent from the other episodes, and generally can have a predictable story arc. In serialized series, the episodes flow continuously and form a consistent whole. Serialized series can be thought of as a single long-form movie in which the story arc often flows across the entire group of episodes. An anthology series generally presents a different story and a different set of characters in each episode, season, segment or short; anthology series episodes often span through different genres.

Series add complexity to a media genome for multiple reasons. First, series have episodes, seasons, as well as the overall notion of a series. Genomics for a series need to be potentially discussed at any of these levels. Moreover, for each of these levels some genes can be described directly while others may need to either ‘roll up’ from a lower level in the hierarchy or ‘pass down’ from a higher level.

Second, episodes in series may have either similar genomics or wildly different genomics. As an example, the media title Altered Carbon from Netflix is a very consistent serialized series and would be expected to have a very similar genome across episodes. Masterpiece Theater, on the other hand, is much more an anthology series and would be expected to have highly varied genomics per episode. The wider the variance in the genomics of episodes, the more difficult it is to assign a specific genomic description to a series or season overall. The same kind of variance often occurs between seasons. That is, the genomics of episodes in two seasons may be similar within each season, but when looking across those two seasons the genomics of the episodes vary extensively. Scrubs or Lost, both very popular series, are examples of this phenomenon.

Third, characters come and go from series, often even major characters when the series is long-running. Character-related genes form an important portion of our media genome. Major character changes can cause substantial changes in the genomics of episodes.

Fourth, other aspects of series may also change, even in serialized series. Core locations that are centerpieces of a series can go from real-world to fantasy-world from one season to the next. The realization of a theme can go from happy or calm from one part of a series to dark or suspenseful. There are numerous other examples. The result is that it becomes very hard to describe the genomics of a series or season when major changes occur to various intrinsic elements of a series.

Fifth, television series include many more categories than are found in film. Films can be documentaries of one form or another. Television, by comparison, has 30-minute nightly national news programs, one-hour local news, hourlong news shows on cable, morning news, weekly news shows (e.g., Sixty Minutes, Dateline), and news specials. Television also has soap operas, reality TV series, late-night talk shows, and extensive sports content that requires special genomic concepts not found in movies. In the illustrated embodiment of FIG. 1, series add episode-level genes 5, season-level genes 4, and series-level genes 3 to the genome.

Video games have their own unique characteristics, and require a separate gaming genome 6. For example, there are games that are about creating stories—called interactive fiction. No such gene exists for that in either film or series genres. Games, however, can be part of a franchise (e.g., Call of Duty), and so franchise rollup algorithms can apply to video games.

Even within these categories, there are specialized types of content that may warrant their own genomes in the form of specialty genomes 7. One example is anime, where the intrinsic features are both extensive but exceedingly different than standard film, series, or video games. Another is AI-based or AI-driven films. The invention is not intended to be limited only to the genomic database shown, but rather extends to any media-centric genomic content, such as music, books, plays/theater, dance, graphic art, etc.

Each major genome has a data structure. As shown in movie genome 1 and series genome 3 in FIG. 1, the main row element in a genome is a unique movie ID, whether that be an IMDB ID, an ID from the Entertainment Identifier Registry (EIDR), some other third-party ID, or an ID unique to the system. Tracked across each row are 1 to n genes associated with that media type. Movies have movie genes; series have series genes. Series genes can be set at the series level, or they can be statistically calculated from either the seasonal genomes 4 associated with the series genome 3, the episode genomes 5 associated with episodes of the series, or a combination of both. Similarly, the franchise genome 2 can have both directly entered franchise-level genes, or genes that have rolled up from either the movie genome, the series genome, or both.

All of these genomes can be grouped into categories, subcategories, and sub-subcategories (columns two through four in category table 8). These groupings are important to help the user community understand the relationships between the genes in each taxonomy. They are also important to make the information architecture in the user interfaces of applications in the collaboration subsystem (described below) more user-friendly. There is no specific organization of categories, subcategories and sub-subcategories to which the invention is limited. The invention, in various embodiments, extends to cover any hierarchical categorization of genes related to visual media.

Genes for films, franchises, series are scored in four different ways in the illustrated embodiment. “Single instance to dominant characteristics” concerns the evaluation of the absence or degree of presence of a single variable—such as whether the show takes place in an Urban Setting, within the milieu of Politics, involving a Parent-Child Relationship, using a College Life-based Plot, etc. These are scored to distinguish between whether the element is one of three things in relation to the media title—namely: Absent, Incidental or Dominant. This is the most common type of field.

A second scoring method example is “Single Characteristics Along a Steady Continuum.” Generally, this quantifies a single variable along a steady continuum—from low to high, small to large, etc., or on a range between two opposite variables on a scale—such as a lead character trait ranging from introvert to extrovert, or detestable to lovable, etc.

A small number of genes, require the “Precise Numbers” scoring method—such as a year of the show's setting, or the age of a character; or a precise text entry (ID)—such as a locale or era not identified in a gene, a venue or mode of travel not identified in a gene, or the catalyst or midpoint of a plot's structure, etc.

For completeness, the description of field types must include the fact that in some cases, the user may need to define an aspect of the media title and then score it. This is the fourth example of scoring, the “Other” text entry category. These genes require special consideration during aggregation and analysis. These four scoring examples are only a subset of possible scoring methods, and the invention in various alternative embodiments is intended cover all other potential scoring methods that could be used.

Where there are levels in the genomic hierarchy, there will also be a need to use some statistical methods to determine how a gene at the superior level, which has antecedents at the inferior level, is calculated. Episodic genes, for example, may roll up to the season level or the series level, depending on the gene. These calculations can be expensive computationally and thus the design of the system is such that it uses as few franchise rollup algorithms 9 as possible to roll up from one level in the hierarchy to the next.

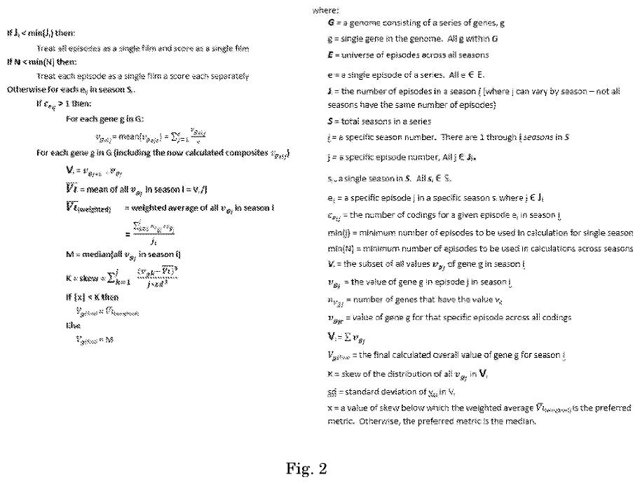

An example of a roll up algorithm that runs in this embodiment of the invention is shown in FIG. 2 as pseudocode. The reason this approach is deemed reasonable is that it allows the system to deal with a wide variety of shapes of distributions of a gene's value across single seasons and a series lifetime. It is a computationally low-cost approach that yields reasonable estimates of aggregate gene values for normal distributions, left- and right-skewed distributions, and bimodal distributions. All of these distributions are common in the distribution of a single gene's values across episodes in TV series. This approach, in fact, uses skew as a major determinant of how to value a gene at an aggregate level. The pseudocode in FIG. 2 shows the calculation for an aggregation from episodes to seasons. There is a similar aggregation for episodes to series in the embodiment.

### The Computerized Genomic System

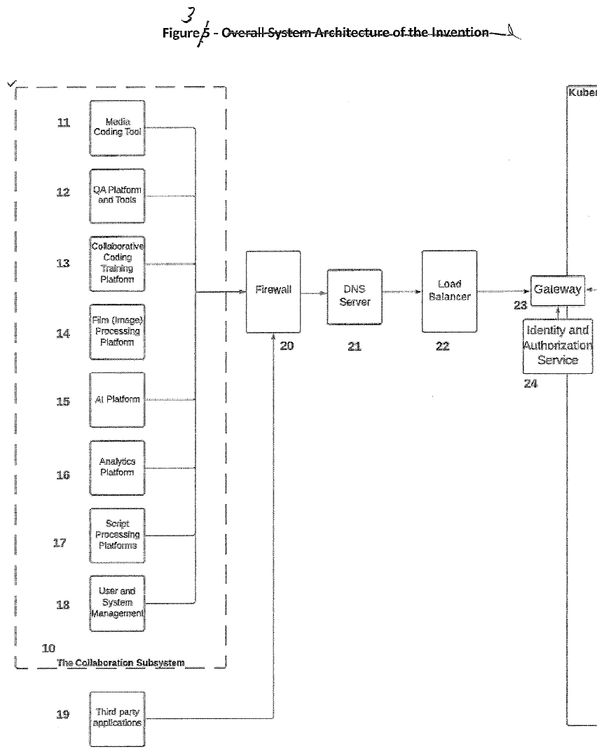

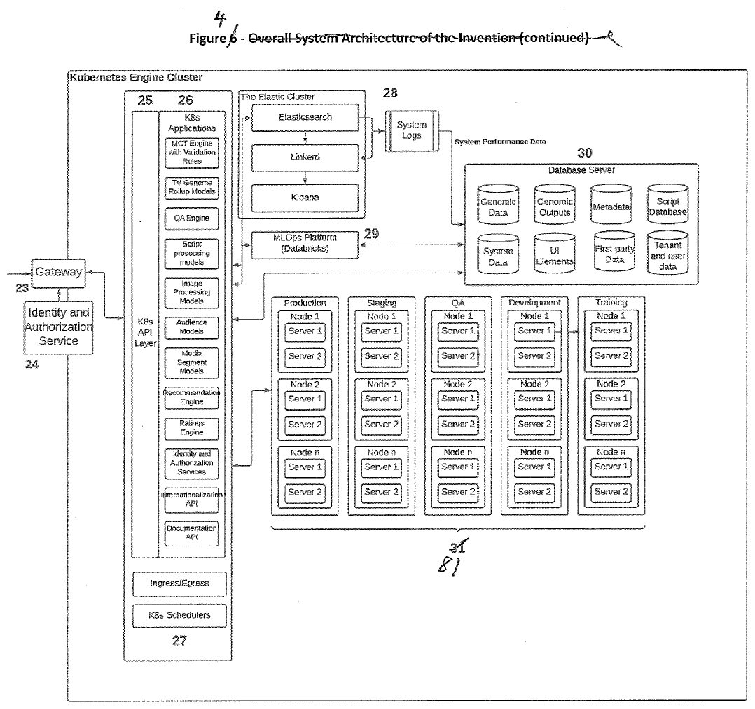

FIGS. 3 and 4 lay out the overall architecture of the system used to create, maintain, deploy and leverage the genome into various use cases and applications according to an embodiment of the invention. The system is completely microservices based, running on a Kubemetes (K8s) Engine Cluster on a major cloud platform. The first seven elements, which are media coding tool 11, QA platform and tools 12, collaborative coding training platform 13, film (image) processing platform 14, AI Platform 15, analytics platform 16, script processing platforms 17, and user and system management 18, are front-end applications that are either part of or associated with the invention and comprise the collaboration subsystem 10. The platforms that comprise the collaboration subsystem 10 are the main interfaces for the human-mediated, collaborative work required to code media at the exacting level required by this invention.

At the same time, the embodiment described here includes a back end whose functions can be accessed through a K8s API layer 25 through which third-parties who are members of the community may write third-party applications (apps) 19 to enhance the ability of other community members to better understand and code media titles.

Each of these applications draws on the backend system and apparatus consisting of elements 20 through 30 and 81. The firewall 20 controls network access into the backend system and prevents unauthorized traffic from accessing the internal network. Behind this is a DNS Server 21 that provides name space services for all of the systems and APIs. A load balancer 22 routes incoming and outgoing traffic across multiple web servers to maintain adequate response times to users of the system. The gateway 23 routes traffic from incoming requests to the appropriate APIs and servers on the backend system. It is at the gateway that user identification, authentication and authorization occur via the Identity and Authorization Management (IAMs) service 24. The IAMs service 24 draws on a multi-tenant authorization service accessed via API endpoints that sit in the K8s API layer 25 in front of the various K8s applications/pods 26 that are deployed via the K8s engine. All APIs are served outbound via an ingress/egress server 27 which provides services like aliasing of endpoints. A K8s scheduler (part of ingress/egress server 27) assigns pods to nodes. The scheduler determines which nodes are valid placements for each pod in the scheduling queue according to constraints and available resources. The scheduler then ranks each valid node and binds the pod to a suitable node.

The IAMs service provides fine-grained access/authorization to resources on the backend of the system, including the APIs and various data sets stored in the database server 30. Examples include allowing a user to have access to the analytics services but not the audience modeling services, or allowing some individuals to access only certain media titles for coding versus those who can access any media title for coding. This subsystem is discussed in more detail in the Media Coding Tool section below.

These “front end” services are tied to four major back-end functionalities: a Database Server Hosting Multiple Databases 30; an Elastic Cluster tied to LinkerD 28; a Machine Learning Operations (MLOps) platform 29; and a series of servers 81 that deploy UI functionality for the various applications listed in 11 through 18, including production, staging, QA, development, and training.

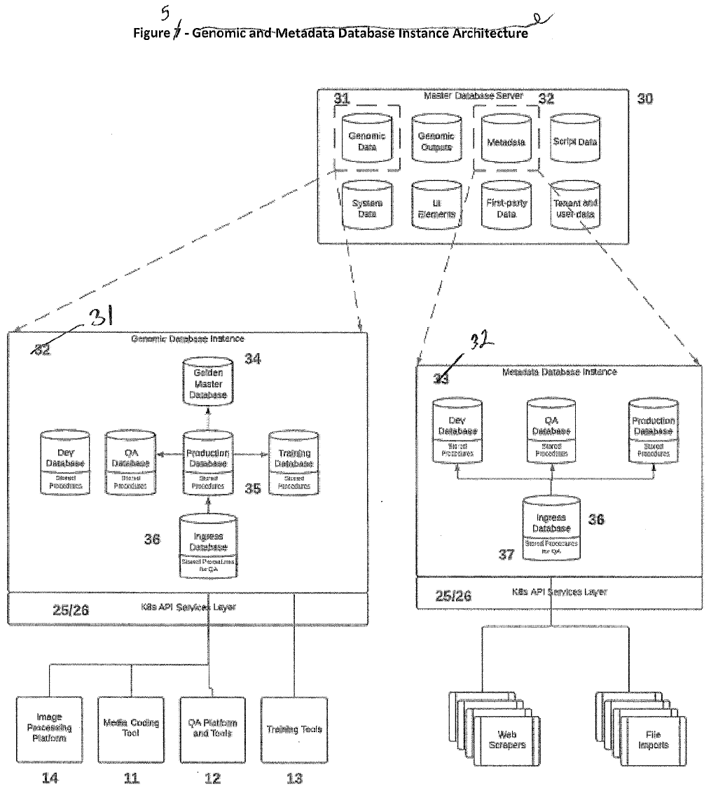

The master database server 30 (shown in detail in FIG. 5) is a SQL-based server data store that holds multiple databases needed to deliver system functionality. In this embodiment of the present invention, there are eight databases: Genomic Data; Tenant and User Data; Metadata; System Data; UI Elements; Script Data; Customer First-Party Data; and Genomic (Product) Outputs. Each database has a specific instance that is accessed by various APIs deployed as a K8s service/pod (25 and 26). Each database instance has a development, QA and production database within its instance. The Genomic data database 31 and Metadata data database 32 instances have an ingress database 36 within their instances. The ingress databases 36 are used to collect data from multiple sources—which can be web-based, file-based, algorithmically-based, or manual entry-based—clean the data, and then put the final, approved genomic or metadata into the various databases within the instance. The Genomic Database instance 31 also has a Golden Master database 34. The Golden Master is never touched by humans, only by a set of stored procedures 35 from the genomic production database. Coded records entered in the ingress database are reviewed on the QA Platform and Tools 12 and approved or rejected. Once a day, in one embodiment, a set of stored procedures 35 runs on the production database and updates the golden master database 34 with any new approved records.

All database instances reside in high-availability clusters with redundancy provided by the underlying cloud platform. If one database instance has planned or unplanned downtime, the high availability cluster fails over to a separate working database instance.

Genomic Database 31 is the core repository of collaboratively-sourced genomic codings and has the architecture previously described with respect to FIG. 1.

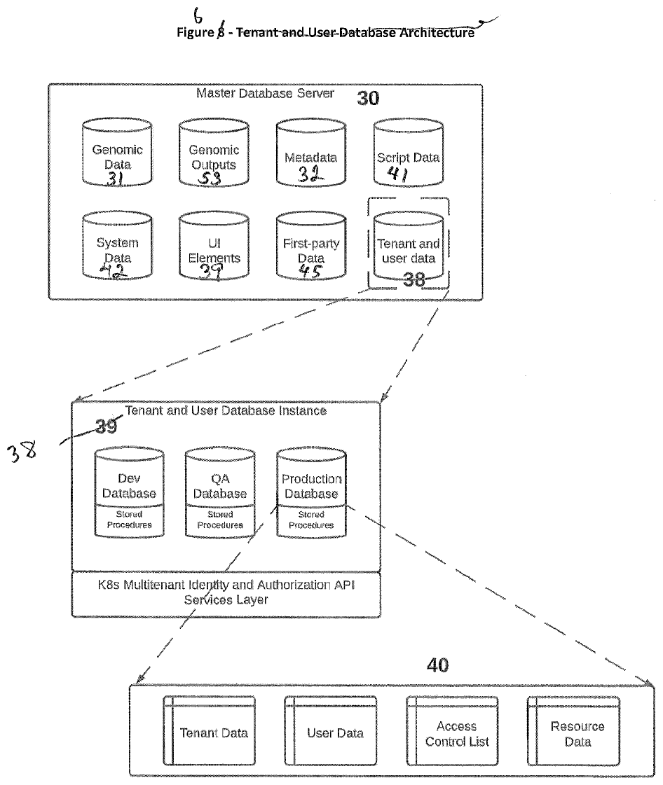

The Tenant and User Data database 38 (shown in detail in FIG. 6) contains the information used by the IAMs service to identify, authenticate, and authorize users into the system. It has four main tables 40 containing tenant data, user data, information about resources that can be accessed, and authorization data (in the form of an access control list) that matches tenants and users to rights relative to specific resources. These tables are accessed by the front-end applications in 11 through 19 via the Identity and Authorization Management services API 24.

Master database server 30 is shown in more detail in FIG. 5. The media coding tool and other applications require movie metadata in order to function. For example, metadata is required in order to identify media titles that are to be coded. Minimal metadata required in an embodiment is media title, IMDB ID or EIDR for the title, release date, as well as the media title's poster and trailer. However, the metadata data store can hold more extensive metadata—e.g., media title box office, cast, awards—within the scope of the invention. The one important thing to note is that metadata on media titles is easily available but hugely inconsistent. This invention therefore assumes an ingress database 36 (shown in FIG. 5) where multiple sources of metadata are loaded and compared using stored procedures specifically designed for data quality assurance.

The System database 42 includes documentation needed for the media coding tool and training platforms, training materials for the collaborative coding training platform 13, data required for internationalization and the internationalization API (one of the K8s applications/pods 26), and log file data from system activity, among other elements.

UI Elements database 39 contains elements needed to construct the user interfaces (UIs) for the various applications. This database is needed because metadata and genomic data can change frequently, which then requires changes in the UI. Making the UI database driven, combined with an API layer, creates an abstraction model that make it easy and efficient to change the UI of the applications.

The Script Data database 41 contains either full scripts or transcriptions of closed-captioning for each media title. This data is acquired through various methods, including transcription of speech from a media title's video using the Film (Image) Processing Platform 14 to capture a media title's close captioning, and import of script files found online or received directly from content owners (all identified as script support 43). This data is then fed into models to pull out intrinsic elements of the media and automatically post it into the genome. This does not occur for all titles, nor does automation work for most genes at the time of this invention, which is why a human-mediated, collaborative approach is needed. However, this invention allows for the application of this type of automation for some genes across all title types. An example is mood genes, which today's NLP technology can tease out from scripts without much human mediation.

Part of the benefit of the invention is that companies that have behavioral data (e.g., what people have watched), such as streaming services, can potentially take the output of the genome—genomic products—and apply them to their titles and viewers to create taste-based audiences or improve recommendations for titles to watch, among other use cases. Thus, the invention provides for separate customer first-party data databases 45 for each customer's first party data sets that can then be processed at the same time as genomic and metadata. This provides more complete information for those companies wishing to model behaviors and better understand the reasons for them.

The data that resides in the genome itself is raw material. Once it resides in the Golden Master database 34, it never leaves the system. Instead, it is acted upon, either alone or in conjunction with metadata or customer first party data, via the AI Platform 15 to create models which are delivered via the MLOps platform 29 into K8s-based services 26 that can be delivered via K8s APIs 25 to the various front-end platforms 11-19. In certain instances, these models represent complex genomic factors, media segments, or audience segments that can be sold to third parties separately from the front-end tools of the Collaboration Subsystem 10 (e.g., as .csv file outputs). This information is stored at genomic outputs database 53.

The Elastic Cluster 28 (shown in FIG. 4) captures data on all activities of the system. This includes not only operational data such as whether a specific K8s service is operational and, if not, what error message it threw, but also user activity data that can be used to understand user behavior. The Elastic Cluster consists of three separate applications running as K8s services. Elasticsearch is an open source, full-text search and analysis engine, based on the Apache Lucene search engine. It includes a log aggregator that collects data from various input sources, executes different transformations and enhancements and then ships the data to various supported output destinations. Linkerd is a service mesh. It adds observability, reliability, and security to Kubernetes applications without code changes. For example, Linkerd monitors and reports per-service success rates and latencies, automatically retry failed requests, and encrypts and validates connections between services. Kibana is a visualization layer that works on top of Elasticsearch, providing the ability to analyze and visualize the data.

The Machine Learning Operations (MLOps) platform 29 provides a data science platform, accessed via the Analytics Platform 16 and AI Platform 15 in the Collaboration Subsystem 10, that allows data scientists to create machine learning models based on genomic data, metadata, stored scripts, customer first-party data, or some combination. It allows data scientists to collaborate across the entire data science and AI workflow. Data science teams—from data engineers to analysts to data scientists—can collaborate across all their workloads. It supports the easy deployment of these models into K8s-based services 26 which are then accessible through the K8s API layer 25. An example is the genome-specific models that allow for series-level genes to be created from episode-level and season-level genes. It provides additional access and authorization controls to the platform by allowing administrators of the MLOps platform 29 to limit access to specific datasets to specific data scientists based on rules established via contracts with customers or data suppliers. Customer first-party data often comes with restrictions on how that data can be stored and accessed that go beyond the standard authorization controls built into the overall system via the IAMs Service 24. This impacts the data engineering and data science teams specifically, so the added controls are maintained at the MLOps platform 29 layer.

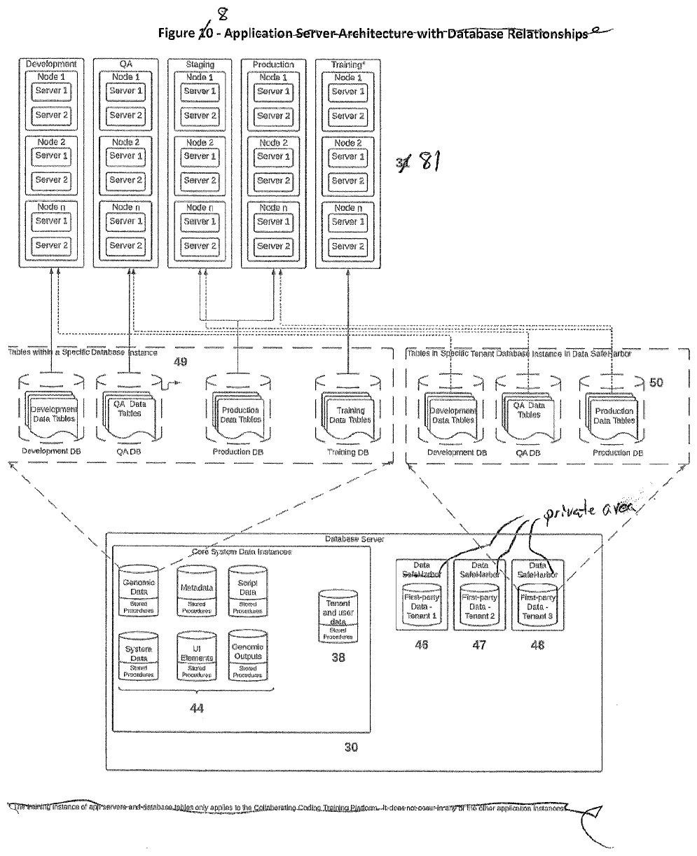

Behind all the other functions are the core applications servers 81, as shown in FIG. 4. These servers serve up the user interfaces for all the applications in the Collaboration Subsystem 10. Each separate application platform (11-18) has its own set of servers—development, quality assurance (QA), staging, and production, as shown in FIG. 8. These are stages in the release cycle of various software. Engineers develop applications on the development server. This code is pushed to the QA servers, where the QA engineers review and either reject or approve the release. Development continues on the development servers until QA approves the release. At which time it moves to the staging server. The purpose of the staging server is to test the code against the production data tables before it is released to production. Once the code is tested against the production database tables, it is moved onto the production servers and made available to end users. These servers use tables 49 and 50, with tables 50 being specific to a tenant and user data database 38.

There is one case in which there is a fifth app server instance—and this is specifically for the Collaborative Coding Training Platform 13. There is a need for a platform which has its own training data tables where new coders who are being trained and certified can learn how to code without impacting any of the development to production flows and data.

All servers are deployed in tandem in containers within a node in K8s to provide redundancy in the event of a server failure or to allow hot swapping of server configurations without interrupting service. When the individual node reaches certain performance thresholds—e.g., 80% processor utilization—the microservices-based architecture allows for the automatic deployment of as many nodes as possible to maintain system performance against key metrics

Underlying each of these app servers are all the database instances in the master database server 30. These database instances come in three types. The core system databases for the platform 44, which are owned and operated by the company/service developing and running the platform, include the genomic, metadata, and script databases, as shown in FIGS. 4 and 6.

The tenant and user database 38, as shown in FIG. 6, is also owned and operated by the company/service developing and running the platform. Data instances are owned by first party data owners (46-48), either customers who put their data on the platform or data providers who have made their data available to the company/service developing and running the platform. Customer data like this is kept in isolated data repositories for security and privacy reasons. Therefore, they reside in their own protected data area with special security controls, including access and authorization rights controlled by the customer (tenant) via the IAMs service within K8s applications 26.

Each of the core system database instances 44 have three databases, each of which contain the data tables needed to support the application servers. Note that the Collaborative Coding Training Platform 13 has a fourth database to support the training application servers for that application. The development databases support the development application servers for all applications (11-18) in The Collaborative Subsystem 10. Similarly, the QA database supports the QA application servers for all applications. The production database and its tables support both the staging servers and the production servers. This is because the staging server, as discussed above, is meant to allow testing of code against the production database before the code is pushed to production.

The Collaboration Subsystem 10 represents the front-end applications to the system that are used to allow efficient, effective, and quality coding of media titles; development of machine learning algorithms that support the functions of the system; analytics that support understanding of media by end users and allow senior analysts (individuals who manage and review coders work) and other managers to track activity on the system. As noted above, there are eight applications that make up the Collaboration Subsystem 10: the Media Coding Tool 11, the QA Platform and Tools 12, the Collaborative Coding Training Platform 13, the Film (Image) Processing Platform 14, the AI Platform 15, the Analytics Platform with Dashboards 16, the Script Processing Platforms 17, and User and System Management Tools 18.

User provisioning and management is a complex function in the Collaboration Subsystem 10. The community that uses the platform makes up a diverse segment of the population worldwide. These may include employees of the owner of the system who perform a variety of different functions on the system (e.g., system analysts, senior analysts); university students who are hired to code movies; studio employees and executives who wish to understand their content; independent content creators (e.g., screenwriters) who wish to understand their content; actors and other talent in the industry, along with their booking agents, as well as independent production companies who want to understand which roles might be a good fit for which talent based on their own genomic description from media titles they have appeared in, worked on, or produced; brand executives who wish to know what media titles to sponsor or place their products into; film lovers and experts who self-select from the general public to code movies (along the lines of a social tagging/content site like delicious or Wikimedia); film lovers and experts who self-select from the general public and earn the right to be reviewers and curators on the system. Each of these groups have very different needs for identity authentication and authorization. Some examples of these different cases are as follows.

Example 1: Studio Account User Case. A studio wishes to understand the genomics of a series of scripts in order to choose which to approve (known as “greenlighting”). These scripts are not available to the general public, so only approved employees of that studio may have access. In this case, there is a corporate tenant with a need for protected storage where their scripts reside. That tenant account will be created by a system super-administrator who works for the owner of the system. They then invite the tenant's representative, via an out-of-band communication (e.g., phone, email), to log in to that specific tenant account as its administrator using a userid and temporary password provided in the communication that must be changed upon first login. Basically, this is a Know Your Customer (KYC) approach to authenticating a user in a corporate account.

Upon login and acceptance of the system terms and conditions of use, the system automatically provisions all the system functions, including protected storage needed by that tenant. The administrator of the tenant can then add users to their tenant account and provide them appropriate access to the scripts on the system—maybe some of them, maybe all of them. Only these assigned users, and no one who is not part of this tenant account, may see these scripts or their subsequent codings. This administrator then uses the script processing platform to upload their scripts automatically into the system for analysis by their approved coders on the account.

A user as just described may have to have access to any content that resides in their tenant protected storage; all media title codings available to general users; raw codings of the media titles residing in their protected storage (private codings); QA'd codings of the media titles residing in their protected storage (private QAd codings); the Media Coding Tool 11; the QA Platform and Tools 12; the Collaborative Coding Training Platform and Tools 13; analytic dashboards which show not only all the media titles available to the general public but also their own private codings 16; and the Script Processing Platform that allows them to upload their scripts 17.

Example 2: General Public Curator. A film lover has heard about the community and wishes to join. They go to a home page and perform self-service registration. They accept the terms and conditions of user and submit their registration. They confirm their identity via an automated email to the email address they provide. At this point, they are a general system user with access to the Collaborative Coding Training Platform and Tools 13 and a few simple analytics dashboards in the Analytics Platform which are available to all users of the system 16. The user undertakes training and when they pass certification, their authorization level is automatically updated to include access to the Media Coding Tool (MCT) 11. The user now begins to code and codes a large number of media titles. Senior analysts on the system see that they have coded titles at a high rate, the quality of their codings is superior, they have provided help to members of the community via messaging on the MCT 11, and their peers have given them high marks and they have established a “superior coder” ranking. At this point, the senior analyst requests that they become a public curator on the system and they accept. The senior analyst goes to the user management screen in the MCT 11 and changes their access level from “general public coder” to “coding curator”. At this point, the curator now has access to the QA Platform and Tools 12 and an extended set of analytics dashboards on the Analytics Platform 16.

These two examples give a sense of the complexity involved in user provisioning and management that the system must support. The invention, in various embodiments, extends to all use cases for provisioning an authorization that can occur on the system, and is not intended to be limited to just the use cases described above.

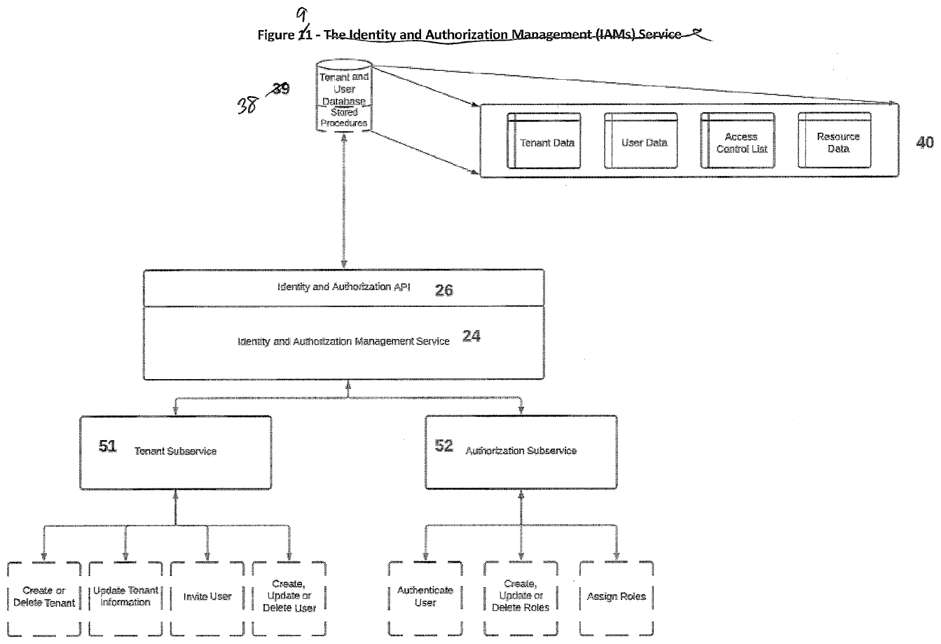

The IAMs service 24, shown in detail in FIG. 9, is delivered via two sub-services: the tenant service 51 and the authorization service 52. The tenant service allows for the creation of the tenant on the system and allows the system administrator to provision new users within the tenant. The authorization service allows for the creation of roles, assignment of users to roles, assignment of resources to those roles, as well as ties to an access control list with authorization rights to those roles and resources.

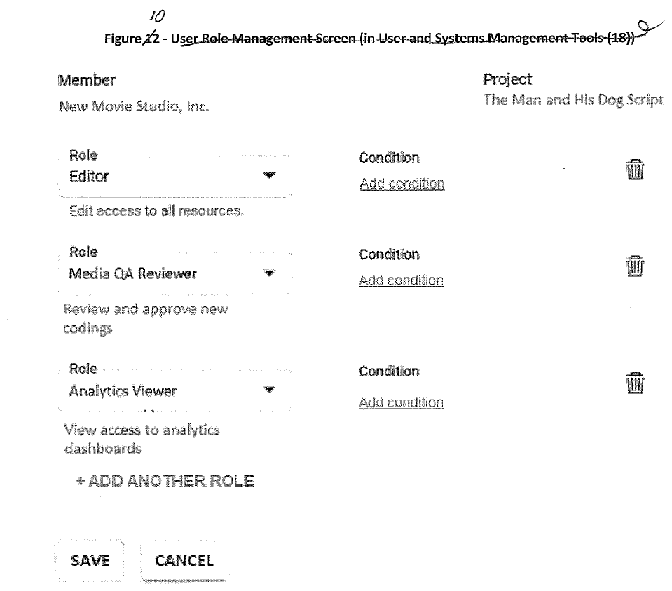

Roles can be defined by a tenant administrator specifically for each tenant. These roles only apply within a given tenant, using the user role management screen as shown in FIG. 10. There are some “super-tenant” roles that are needed by any super-administrator of the system. For example, the system super-administrator needs to be able to provision tenants or reset tenant administrator passwords. These functions are not available within a tenant.

The tenant service allows users to register with an email address, a social media ID, or a mobile device ID like an Apple ID or Android ID. Which IDs can be used depend on the use case. Social media and mobile device IDs are not an option in KYC-based scenarios, for example.

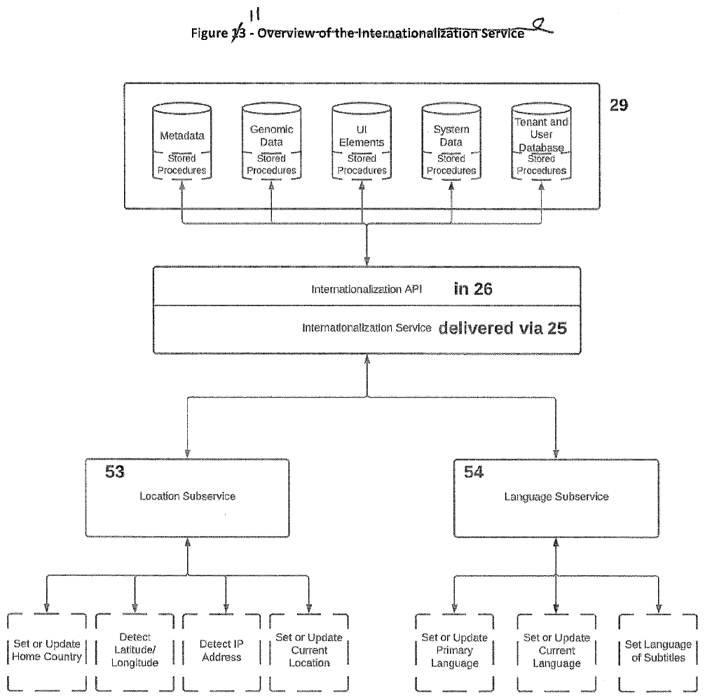

The system is designed to handle media and users worldwide. There is an K8s-based internationalization service, shown in FIG. 11, delivered through API 26 that allows for internationalization and localization. This localization functionality includes changing the language of UI elements to the preference of the end user or based on their latitude/longitude or IP address, changing the movies presented based on selected geographies, changing which movie metadata is shown (e.g., movies often have different titles even between English-speaking countries), changing the selected subtitle language as the movie is viewed, among other features.

The internationalization service has two primary elements: a location subservice 53 and a language subservice 54. The location subservice is responsible for detecting and setting both home location and current location. The language subservice sets the primary language as well as the secondary language to be used.

The Media Coding Tool (MCT) 11 is the tool used by coders in the community to add tags to the database for specific media titles, either interactively as they watch the media title or after watching it from notes taken during a review of the title. The MCT 11 has five elements for end users: Media Selection Functions; Media Coding Functions; Documentation; Note taking; User Activity History; and Community Functions.

The MCT 11 is tightly integrated with the metadata database 32. This is where the list of media titles to code in the media selection screens and media assignment screens is stored. As the metadata database updates for newly-released titles or corrections (e.g., movies do change names on occasion, especially in international markets, release dates tend to be updated, movie poster artwork is updated), so do these screens.

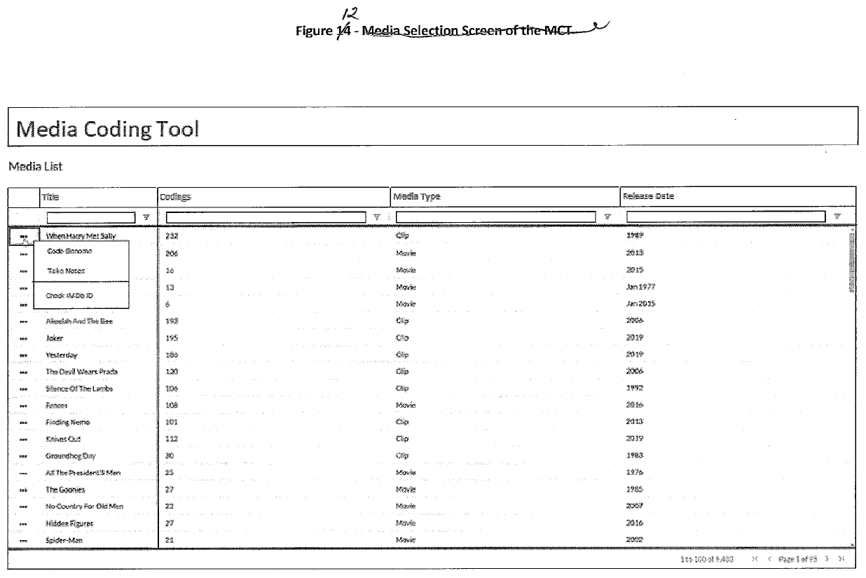

When a user enters the MCT 11, the first thing they are presented is the list of media to code. The screen used for this purpose is shown in FIG. 12. This list varies based on the tenant they are part of and the access rights they have as part of their role. They may only see media titles from their company, from certain directors, in current states of production, for only certain countries, as some examples. When they select a media title to code, this either creates a new entry (a “coding”) in the genomic database or returns them to an entry that has already been started but it not yet marked as submitted.

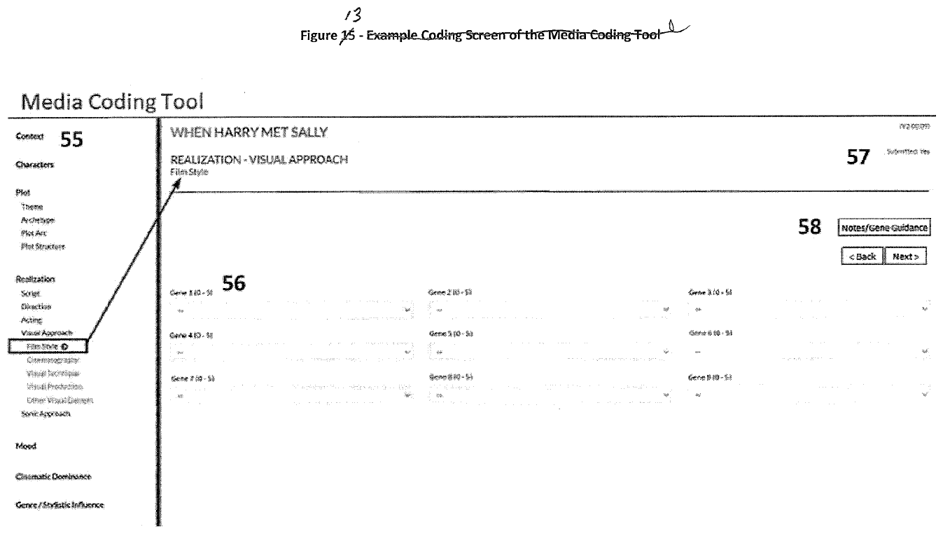

The media coding functions allow users to actually tag the media titles according to the structure of the genome, with an example screen shown in FIG. 13. The use of categories, subcategories and sub-subcategories allows designers to build a navigation 55 that is easy to follow and splits the work into conceptually manageable “chunks” for a user. For example, all genes related to film style are shown on a given page; all genes belonging to plot appear on a different page.

The system displays the gene name and its coding scale 56 for all genes in that particular subcategory or sub-subcategory. The entries are saved as they go, but often coding sessions may be interrupted and occur over several days. So, a coding remains “open” until a coder indicates to the system that the coding of that particular media title is done. At that point, the user hits a “submit” button and the record is locked and submitted for QA review. The record shows its status 57 on the top right of the screen. If the QA algorithms reject the coding, its status reverts to “in process” and continues in that status until the genomic code resubmits the coding. This can happen multiple times until the coder indicates to the system that there are no further changes.

In the disclosed embodiment, no records are ever discarded. All entries in progress are maintained in their current state. If more than one version of a coding for a media title is submitted by the same person, then the later coding remains active while the prior version is archived.

Training and certification in coding for the platform, as well as help provided by other coders in the community, go a long way to assuring the fundamental soundness of tagging. However, the system also has built-in checks to ensure codings meet a minimum standard. One check is enforced scoring rules. Singular entries that differ from what is expected and required are denied. Users are instructed to correct these entries. These are enforced on the client at the time an entry is made into a field. In addition, there are enforced validation rules. In some cases, while the singular entries may be correct, when assessed in combination with others, they cannot be valid. These validation rules are instantiated as stored procedures in the genomic database and are triggered/enforced at the time a web page with new entries is posted to the database or when the record is submitted. For example, while each of three genes can be coded a “5”, when considered together, the total score can be no more than “10”. Depending on the situation, this requirement means that if one gene is scored a “5”, the other two must combine to score no more than “5”—either “3” and “2”, “3” and “1” or “4” and “1”. In some cases, one of the three genes in question can be left blank and thus a score of “5”, “5” and “blank” is acceptable.

Before entering a database that holds records available for manual review, the record is evaluated to ensure that an appropriate percentage of the coding has been completed to qualify for review. This assessment not only includes the percentage of the entire coding completed but also if each section is appropriately completed.

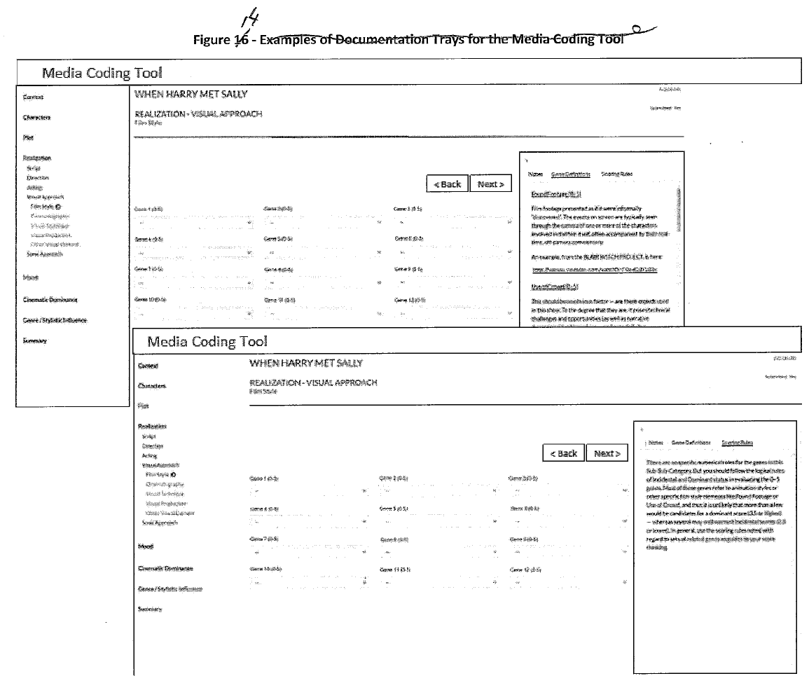

Documentation using the system may be described with reference to FIG. 14. There are three sets of documents that can be accessed during the coding process so that the results are consistent and accurate. The first is the user manual, which provides a complete overview of the genome and scoring process that can be always accessed. The second is gene definitions. As users code and transition through the various Subcategories and Sub-subcategories the definitions of the specific genes and how to score them are displayed. The third is scoring rules. Following the same process, as users code media titles special scoring rules are displayed.

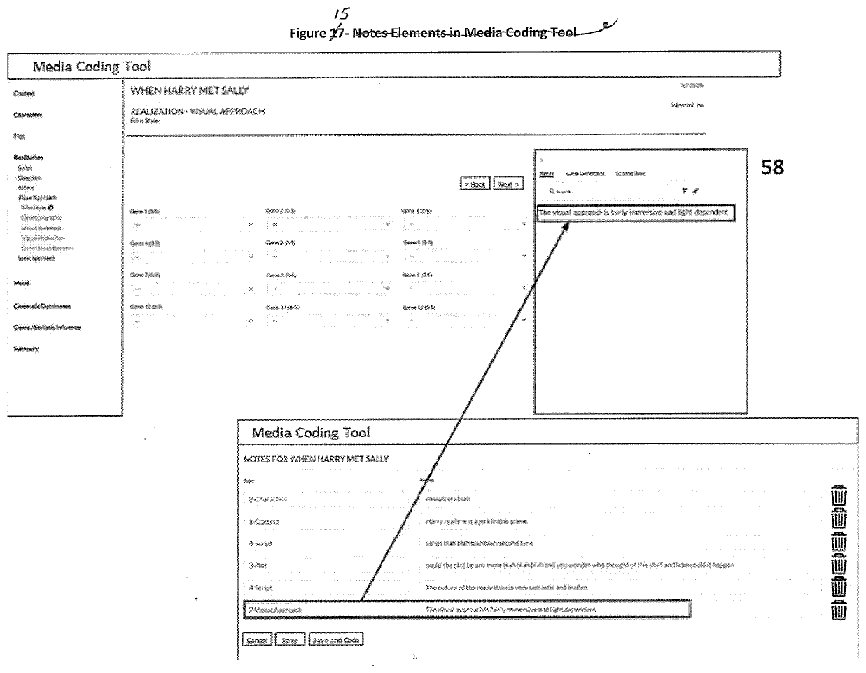

FIG. 15 shows a screen for note taking within the media coding tool. As users watch the media to be scored, they can enter notes for each Category, Subcategory and Sub subcategory 58. They will refer to these notes as they enter scores into the system. They can see these notes inline in the coding screens or they can see all their notes in a notes view.

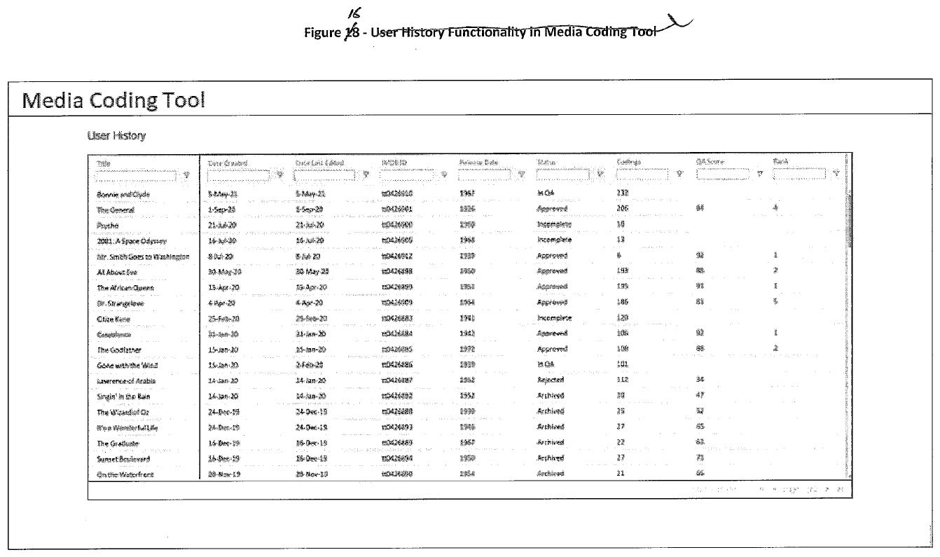

Users will want to know what they have done on the system. Did I already code that piece of media? Which of my codings are still in process versus submitted? Which of my codings was approved for the Golden Master and why? FIG. 16 shows one example of the functionality that the platform provides to users to analyze their history and track their performance.

Community functionality is important in this collaborative setting to encourage participation. This is particularly true in the case of media, an area where people are active and expansive creators of content on review sites and social media platforms. The embodiment of the invention described herein includes a number of community functions in the MCT 11 as a way to encourage participation and stickiness. “Friending” allows users to request friends to join their network so that they can share insights into media, coding techniques, or other areas of mutual interest. The platform also has algorithmic capabilities to rate a coding against best practices. This is known as a Quality Score. Each user's codings will be given a Quality Score and shown publicly, if they provide permission to do so. These ratings then become the basis for users to rate codings and coders. Also, users can rate coders based on the quality of their codings, their contributions to social media on the platform, as well as the level of activity and support they provide to other members of the community. The system includes badging to indicate various levels of expertise. The levels are algorithmically determined based on number of codings, the rate of codings, the quality of codings, the level of participation in social media on the platform, and user ratings. The system includes shared notes. The notes activity in MCT 11 can be performed privately or individuals can share their notes with friends or the general community. The MCT 11 allows individuals to perform searches that will bring back all shared content on the platform that relates to the search terms they typed in. This includes publicly available codings, shared notes, biography pages, and the newsfeed. MCT 11 includes a newsfeed where users can make entries and read the entries of others on the platform. Finally, individuals can create a biography page to share with others.

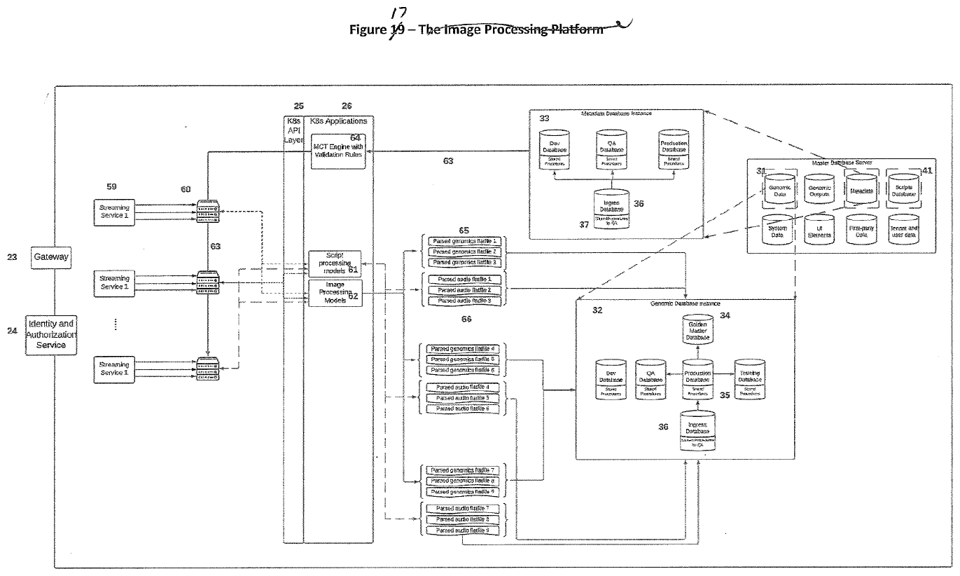

FIG. 17 shows the elements of the Image Processing Platform. The Image Processing Platform uses artificial intelligence to view films and extract critical genomic data. These algorithms, however, can only pull a portion of the total universe of genomic elements that are coded. As such they are supplemental to human coding using the MCT 11. Over time as the algorithms improve, it is anticipated that more of the work done by human coders will fall to AI-driven automation. However, even today, image processing algorithms, as well as algorithms that can do text/speech processing from viewed film content, can reduce the number of hours needed to score/code a film prior to entering the QA cycle.

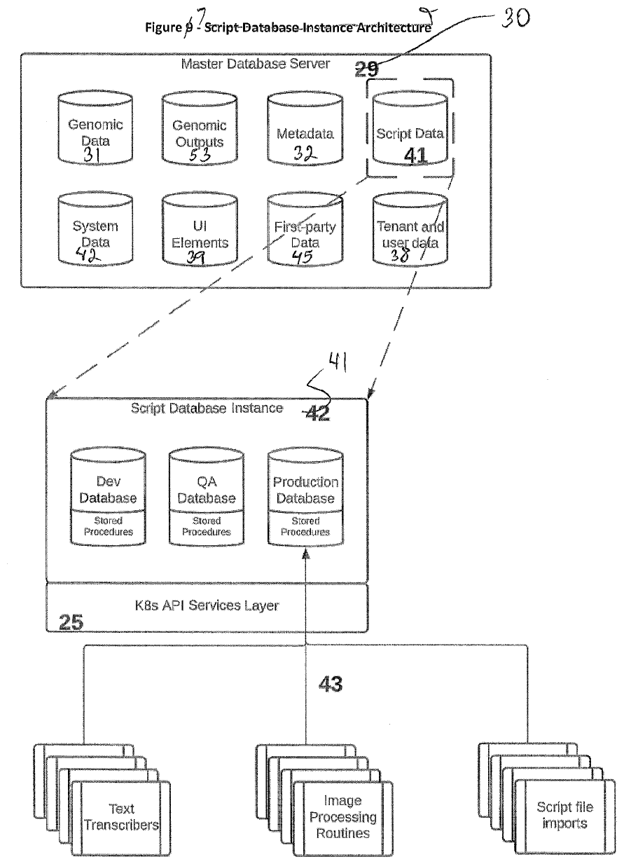

The Image Processing Platform includes a number of image processing servers 60 which are attached, via URLs on apps, to various image streaming services 59. Software residing on each server can scan each piece of content as it is played. The content is identified via its metadata 63 which is provided by the metadata database instance 33 via the MCT Engine with Validation Rules and its APIs 64. As each piece of content is scanned, the software draws on the script (text) processing models 61 and image processing models 62 that reside in the K8s applications layer 26 via the K8s API layer 25 and collects data in structured flat files (e.g., .csv). Each piece of content generates two files: a genomic file containing genes derived from the visual elements in the content as interpreted by image processing models 65, and a parsed audio file 66 that contains genes and their estimated scores collected from the conversational elements, as well as the closed captioning elements, in the content as interpreted by the script processing models 61. (These are similar, but not the same, as the models described with respect to the script database 41 and as shown in FIG. 7.) These models, however, have an extra step: they must first capture the text from audio or close captioning and then process them in the same way the script processing models in association with script database 41 do.

Once this process is complete, the files are then processed and the data entered into the ingress tables in the genomic database 31. The files do not need to go through the validation process because the APIs have validation rules built in specific to the genes that it can capture. This data, along with the manually entered data, is then ready for quality review. Various image and audio processing techniques may be utilized, all of which are intended to be within the scope of the present invention as alternative embodiments.

Validation rules, scoring rules, and completeness checks are appropriate ways to ensure that codings of media titles are correct relative to the logical relationships between genes. That is the first level of quality assurance for codings, and these relationships hold true for every media title coded on the platform, whether they are publicly-available codings or privately-maintained codings such as an unreleased movie script coded by studio personnel prior to greenlighting that are confidential and only available with tenant authorization in a specific tenant's protected area. But there is another level of quality assurance, which is whether or not a coding truly captures the intrinsic features—the “DNA”—of a media title. This is a subtler challenge to undertake because it involves human perceptions that cannot be reduced to simple logic that can be instantiated as a stored procedure in a database. Individuals who code can have very different reactions to the same stimulus, and thus different perceptions of specific genes' importance to the title. In addition, individuals who code have differing levels of knowledge of media. For example, some viewers may not be familiar with the subtle features of film noir at the same level as an individual who is a fan of the genre. Individuals, even when trained and certified, may score the same genes differently. There are always grey areas between scoring levels where something could be ranked as a 2.5 or a 3, for example. One coder may rate on one side of the scale, while another may rate on the other. Thus, there is a need for a second type of quality assurance, one which reviews all the codings of a specific title and determines which codings best represent the intrinsic features of a media title and should be allowed in the Golden Master database 34. That is what the QA Platform and Tools 12 provide to the system and methods.

The QA platform provides a set of user interfaces, tools for manual review of codings, and machine-learning algorithms that review codings to ensure they meet the quality metrics established by the leaders of the community. These leaders can be senior analysts on the payroll of the company which operates the platform whose only job is to review and approve codings; public curators chosen by/from the community for their proven coding skills (e.g., based on their user ranking as discussed in Community Functions, above) who provide QA review and approve codings as a service to the community; or private curators working for a specific tenant within their protected data area, who review and approve codings for individuals approved for access within a specific tenant account.

The QA platform includes a number of tools. These include tools to view codings that have been submitted for review at any time. This includes codings that have been approved, those that have been rejected, those that have been archived as well as those that are currently active. The QA Platform also include tools to view a specific coders' coding history and Quality Scores. In addition, the QA Platform includes tools to allow manual comparison of codings, selection of the best codings of genes and approval of a final record. The QA Tools include tools to allow for archiving of specific records that are not the final approved records for a media title. Finally, the QA Tools include automated machine learning-driven tools that review and rate the quality of a coding (the Quality Score) across a number of metrics to provide another indication of the quality of a specific coding.

The QA Tools facilitate human-mediated machine-learning driven aspects of the system. AI alone cannot yet provide the level of insight needed to correctly evaluate a coding of genes with subtle meanings and implications. That still requires human judgement. However, the machine can learn from human experience. The QA platform is built to make these interactions as efficient and effective as possible.

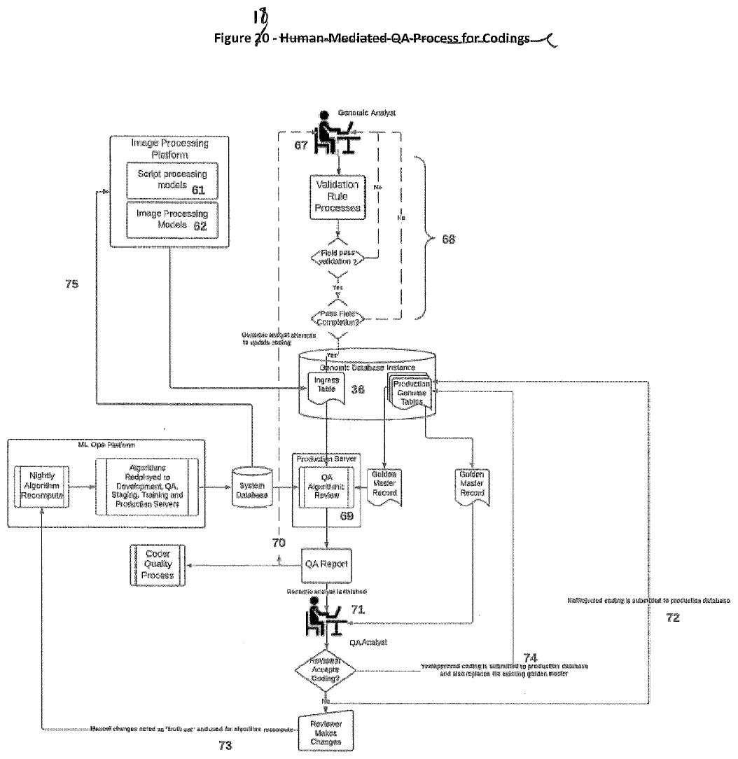

The core algorithms by which the system learns to build the Quality Score may now be described. The system has quality scoring algorithms that review and give a quality score to a coding submitted by a coder. These algorithms can vary, and this invention is not limited to a particular algorithm. The system can run one or more QA algorithms of various types. The human-mediated manner in which the system learns and improves its quality score is shown in FIG. 18. The genomic analyst codes a specific piece of media at step 67. Interactively, the coding is subject to validity and completion checks until the coder finishes and submits the coding at step 68. That coding is not yet reviewed, so it goes into an ingress table 36 in the Genomic Data database 31 where it awaits review.

At the same time, any data generated by the Film (Image) Processing Platform 14 is also deposited into the ingress tables in the Genomic Data database 31. These entries have already been validated during the collection process by the image processing algorithm 62 and the script processing algorithms 61. The entries for the specific genes scored by the Image Processing Platform are matched to any entries by the genomic analysts for the same title based on the content's unique identifier (e.g., an IMDb ID). The automated QA algorithms run on the coding 69 and, if there is an existing Golden Master Database 34, also compares it to that approved version. If it passes the automated QA, it is then forwarded, along with the QA report, for manual review by a genomic QA analyst. If not, the record is reverted to “in process” status and there are two possible outcomes. The rejection is noted to the genomic analyst. Via the QA report, they can see its current Quality Score and why it was rejected. They can then attempt to improve their coding at step 70. Once done, they hit “submit” and the QA process begins again.

If the analysts choose, they can prefer their coding to what is recommended by the QA system and perform a “final” submission, telling the system that they are done. The genomic QA analyst then reviews the new coding at step 71, paying specific attention to areas the genomic analyst left unchanged despite the recommendations of the QA algorithm. These are an indication that human judgment may be “superior” and so requires significant attention of the QA analyst's part. A specific example where this will be common is when films or TV episodes are reviewed by someone in a different country/language/cultural milieu than any prior analyst.

If the record in the Golden Master Database 34 is equal or superior, the golden master remains unchanged. However, the analyst notes the errors in the submitted coding, which are then stored and used in the nightly update to the QA algorithm in order to improve its performance against human judgement at step 73, as well as the image processing 62 and script processing 61 algorithms to improve their performance at step 75. The submitted coding is then marked as rejected and stored in the production database at step 71. If the submitted coding appears superior to the existing golden master in Golden Master Database 34, then the submitted coding is approved, stored in the production database, and replaces the existing coding in the Golden Master Database 34 at step 74.

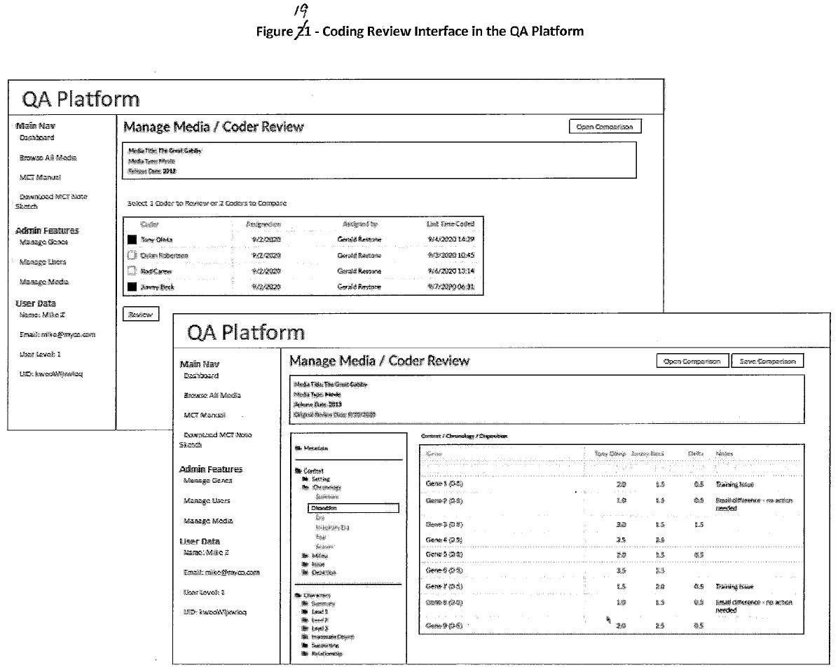

FIG. 19 shows the screen allowing for use of the QA view/approval tool. The QA analyst uses a QA tool to review codings after the QA algorithm is done scoring. The manual QA tool first allows a reviewer to select the media title that has been coded, and then the codings to be compared. The reviewer can then go gene-by-gene through a coding and evaluate which value for a gene, among many, they believe represents the best representation of that gene in the media title. In many cases, the reviewer will watch some portion media title to confirm a specific scoring.

The system allows multiple ways to populate the record intended for approval. These include the ability to select all scoring values for genes from one coding; select all scoring values for genes from one coding within a category, subcategory, or sub-subcategory; select a scoring value by gene from a specific individual, where different scores for genes in the approved record come from different individual codings being compared; and manually fill in a different value for a specific gene or group of genes.

Even though accepted values are coded algorithmically, the human curator can override any final scores generated by the algorithm if they so choose. In this case, the curator's responses are stored and used in the nightly update to the QA algorithm in order to improve its performance against human judgement at step 73 (FIG. 18), as well as the image processing 62 and script processing 61 algorithms to improve their performance at step 75.

Similar to a quality score for a coding, there is a quality score for a specific coder. In its simplest form, a coder's rating can be:

$$\frac{{\sum }_{i = 1}^{n} ( QA {Score}_{i} )}{n} * 100$$

where n is the number of codings done by the coder.
   However, such a simple rating does not consider a broader set of considerations as to whether someone should be considered a “quality coder” moving forward, including factors such as whether their recent quality scores have been increasing, steady, or dropping, their time since they last coded a film or TV episode, or how the community rates their participation in coding activities. One embodiment of the present invention therefore uses a more complex multivariate logistic regression to assign a propensity score to each coder as to whether they are expected to be a quality coder moving forward. This may be expressed as follows:

Log(p(x)/(1−p(x)))=f(average QA score last 3 codings, lifetime average QA score, # of codings, # of codings last three months, # of days since first coding, # of days since last coding, average time between codings, days since last training, community rating, # of positive reviews)

The embodiment of the present invention described herein also uses a similar algorithm for determining a quality coder by genre. This is considered another important metric to consider as some coders heavily prefer one genre over another. Thus, their ability to accurately code a piece of content is better in that genre and an overall average obscures their stronger or weaker propensity across genres. This is only one approach. This invention can handle any coder quality scoring algorithm across any subset of features in alternative embodiments, and is not limited to the calculation above.

Coders can then be ranked based on their quality propensity scores, either overall or by subsegment. The platform owner can determine what the cutoff point should be for someone to be considered a quality coder. Once again, there is human mediation on the algorithm. Senior analysts and community curators who help manage the coders review the rankings as they are published and provide a manually-driven propensity score of their own. These manual propensity scores are then fed back into the algorithm to make it more accurate.

In the early stages of the system and platform, it is envisioned that human mediation on algorithms will be regular and extensive. Human mediation will reduce over time as the algorithms' predictions more accurately reflect human judgement. Instead of reviewing all codings, it may be reasonable to only review a statistical subset using Six Sigma-style methodologies.

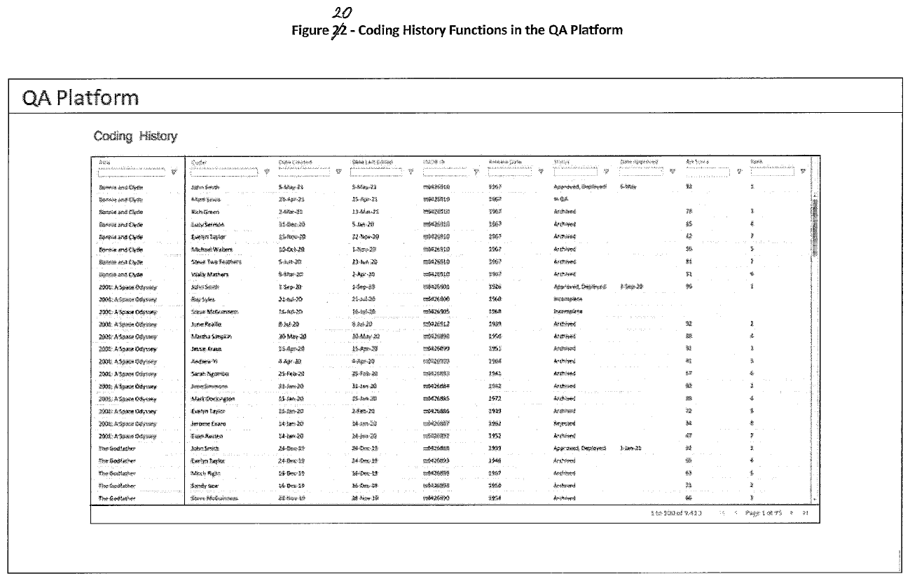

FIG. 20 shows a screen to examine coding history. The QA Platform has tools to allow senior analysts and curators to review and examine the performance of coding around specific titles. Within this functionality, they can quickly examine differences between codings in order to understand what genes have the widest variance in coding and determine what changes, if any, need to be made to a potential golden master to make it more closely approximate the true nature of the content.

Scoring for a specific gene can vary widely due to differences in the background, psychological profile, and media knowledge of the coder. The wider the variance on the value of a gene in its codings, the more difficult it is to determine the correct score for that gene for a specific media title whether it is done using machine learning or in a human-mediated form. The most important way to reduce that variance is to train coders to score genes the same way. The second way, which is described above under Community Functions above, is to allow them to communicate openly in forums and direct messages to share insights on how to score a specific film and reach mutual agreement on what the score for a specific gene should be.

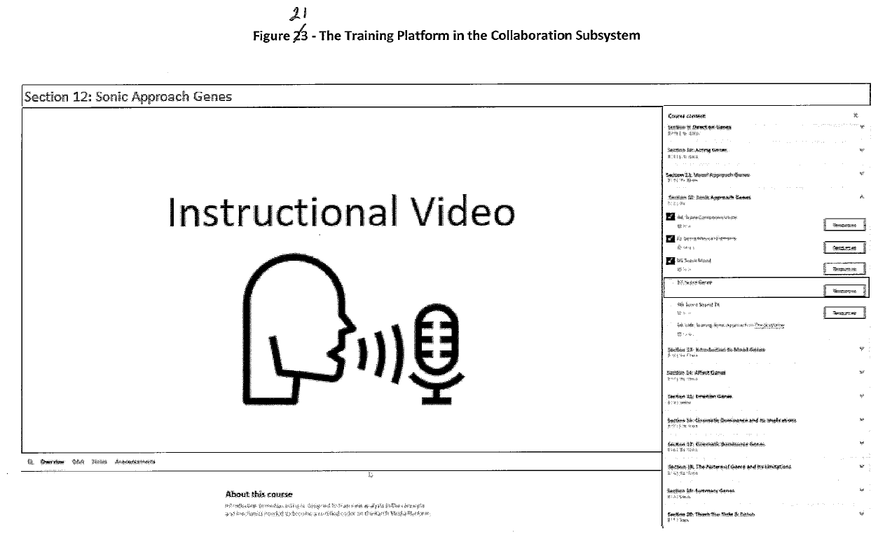

Quite extensive training is required to reduce variance in scorings to a reasonable level, running over multiple weeks. Thus, a training platform is an essential part of the system and methods involved in this patent. The Collaborative Coding Training Platform 13 consists of a series of modules delivered either through live lectures or on-demand video, through a screen as shown in FIG. 21. Each lecture has content to be learned as well as hands-on coding exercises using the Media Coding Tool 11 or, alternately, the QA Platform and Tools 12 for training of senior analysts and coding curators. The training platform can also house exams to be taken at the end of courses to allow for formal certification in genomic coding and associated fields.

The AI Platform 15 allows data scientists to develop, test and deploy algorithms into the system that support all the various functions the system requires. These include: performing the rollups of genomic tables—e.g., from episode to season, from movies, series, video games and others to franchises; MCT 11 validation logic; metadata quality control processing; text and script processing; image processing; QA functions like code scoring, coder ratings, machine-based approval of codings; automated coding of genomic elements through approaches like NLP-based processing of scripts; creation of genomic outputs from the genome for sale as products; and predictive analytics as part of the analytics platform. In the embodiment described herein it is based on Jupyter notebooks, using Python, R, or SQL (among other languages) to develop machine learning models.

The Analytics Platform 16 is a series of analytic interfaces that in the embodiment described herein covers the areas of audience, story, and slate/lineup. Audience is an evaluation of a client's customer behavior and demographics as represented on their database. In line with this description, the behavior is highly reliant of the genomic definition of the media they consume or rate highly. The story is a review of the scripts that are coded and submitted (as discussed previously). The result is reporting that deals with the genomic characterization of the script and the corresponding metadata, audience and market information. “Slate” is a term used in the film business, while “lineup” is used for television. While the names are different, the concept of the analytics that are offered are similar. It lists the media by category for each release cycle. The genome is used to create the categories.

The Script Processing Platform 17 allows users to upload scripts into the system for processing into their genomic components. It allows uploading in several ways. One option is upload of a .csv, Word, or PDF file into cloud storage. From there, the script can either be processed manually or be submitted into NLP-based processing. Another option is transcription of videos as they play using an NLP-based transcription engine. From there, the script can either be processed manually or be submitted into NLP-based processing using algorithms developed using the AI platform. Finally, application of Image processing algorithms to media titles to capture the close captioning on the screen. From there, the script can either be processed manually or be submitted into NLP-based processing.

The user and system management tools 18 allow super-administrators, tenant administrators, application administrators on the system to manage various aspects of their workflow. These include: establishing new tenants and inviting administrative users; inviting new users to the platform; added new roles to a tenant in the system; assigning or reassigning roles to specific users within a tenant; assigning media to specific analysts in the Media Coding Tool Platform 11; and assigning submitted codings to specific senior analysts and public curators for evaluation and approval.

The systems and methods described herein may in various embodiments be implemented by any combination of hardware and software. For example, in one embodiment, the systems and methods may be implemented by a computer system or a collection of computer systems, each of which includes one or more processors executing program instructions stored on a computer-readable storage medium coupled to the processors. The program instructions may implement the functionality described herein. The various systems and displays as illustrated in the figures and described herein represent example implementations. The order of any method may be changed, and various elements may be added, modified, or omitted.

A computing system or computing device as described herein may implement a hardware portion of a cloud computing system or non-cloud computing system, as forming parts of the various implementations of the present invention. The computer system may be any of various types of devices, including, but not limited to, a commodity server, personal computer system, desktop computer, laptop or notebook computer, mainframe computer system, handheld computer, workstation, network computer, a consumer device, application server, storage device, telephone, mobile telephone, or in general any type of computing node, compute node, compute device, and/or computing device. The computing system includes one or more processors (any of which may include multiple processing cores, which may be single or multi-threaded) coupled to a system memory via an input/output (I/O) interface. The computer system further may include a network interface coupled to the I/O interface.

In various embodiments, the computer system may be a single processor system including one processor, or a multiprocessor system including multiple processors. The processors may be any suitable processors capable of executing computing instructions. For example, in various embodiments, they may be general-purpose or embedded processors implementing any of a variety of instruction set architectures. In multiprocessor systems, each of the processors may commonly, but not necessarily, implement the same instruction set. The computer system also includes one or more network communication devices (e.g., a network interface) for communicating with other systems and/or components over a communications network, such as a local area network, wide area network, or the Internet. For example, a client application executing on the computing device may use a network interface to communicate with a server application executing on a single server or on a cluster of servers that implement one or more of the components of the systems described herein in a cloud computing or non-cloud computing environment as implemented in various sub-systems. In another example, an instance of a server application executing on a computer system may use a network interface to communicate with other instances of an application that may be implemented on other computer systems.

The computing device also includes one or more persistent storage devices and/or one or more I/O devices. In various embodiments, the persistent storage devices may correspond to disk drives, tape drives, solid state memory, other mass storage devices, or any other persistent storage devices. The computer system (or a distributed application or operating system operating thereon) may store instructions and/or data in persistent storage devices, as desired, and may retrieve the stored instruction and/or data as needed. For example, in some embodiments, the computer system may implement one or more nodes of a control plane or control system, and persistent storage may include the SSDs attached to that server node. Multiple computer systems may share the same persistent storage devices or may share a pool of persistent storage devices, with the devices in the pool representing the same or different storage technologies.

The computer system includes one or more system memories that may store code/instructions and data accessible by the processor(s). The system memory may include multiple levels of memory and memory caches in a system designed to swap information in memories based on access speed, for example. The interleaving and swapping may extend to persistent storage in a virtual memory implementation. The technologies used to implement the memories may include, by way of example, static random-access memory (RAM), dynamic RAM, read-only memory (ROM), non-volatile memory, or flash-type memory. As with persistent storage, multiple computer systems may share the same system memories or may share a pool of system memories. System memory or memories may contain program instructions that are executable by the processor(s) to implement the routines described herein. In various embodiments, program instructions may be encoded in binary, Assembly language, any interpreted language such as Java, compiled languages such as C/C++, or in any combination thereof; the particular languages given here are only examples. In some embodiments, program instructions may implement multiple separate clients, server nodes, and/or other components.

In some implementations, program instructions may include instructions executable to implement an operating system (not shown), which may be any of various operating systems, such as UNIX, LINUX, Solaris™, MacOS™, or Microsoft Windows™. Any or all of program instructions may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software, processing application) readable by a machine (e.g., a computer). Generally speaking, a non-transitory computer-accessible medium may include computer-readable storage media or memory media such as magnetic or optical media, e.g., disk or DVD/CD-ROM coupled to the computer system via the I/O interface. A non-transitory computer-readable storage medium may also include any volatile or non-volatile media such as RAM or ROM that may be included in some embodiments of the computer system as system memory or another type of memory. In other implementations, program instructions may be communicated using optical, acoustical or other form of propagated signal (e.g., carrier waves, infrared signals, digital signals, etc.) conveyed via a communication medium such as a network and/or a wired or wireless link, such as may be implemented via a network interface. A network interface may be used to interface with other devices, which may include other computer systems or any type of external electronic device. In general, system memory, persistent storage, and/or remote storage accessible on other devices through a network may store data blocks, replicas of data blocks, metadata associated with data blocks and/or their state, database configuration information, and/or any other information usable in implementing the routines described herein.

In certain implementations, the I/O interface may coordinate I/O traffic between processors, system memory, and any peripheral devices in the system, including through a network interface or other peripheral interfaces. In some embodiments, the I/O interface may perform any necessary protocol, timing or other data transformations to convert data signals from one component (e.g., system memory) into a format suitable for use by another component (e.g., processors). In some embodiments, the I/O interface may include support for devices attached through various types of peripheral buses, such as a variant of the Peripheral Component Interconnect (PCI) bus standard or the Universal Serial Bus (USB) standard, for example. Also, in some embodiments, some or all of the functionality of the I/O interface, such as an interface to system memory, may be incorporated directly into the processor(s).

A network interface may allow data to be exchanged between a computer system and other devices attached to a network, such as other computer systems (which may implement one or more storage system server nodes, primary nodes, read-only node nodes, and/or clients of the database systems described herein), for example. In addition, the I/O interface may allow communication between the computer system and various I/O devices and/or remote storage. Input/output devices may, in some embodiments, include one or more display terminals, keyboards, keypads, touchpads, scanning devices, voice or optical recognition devices, or any other devices suitable for entering or retrieving data by one or more computer systems. These may connect directly to a particular computer system or generally connect to multiple computer systems in a cloud computing environment, grid computing environment, or other system involving multiple computer systems. Multiple input/output devices may be present in communication with the computer system or may be distributed on various nodes of a distributed system that includes the computer system. The user interfaces described herein may be visible to a user using various types of display screens, which may include CRT displays, LCD displays, LED displays, and other display technologies. In some implementations, the inputs may be received through the displays using touchscreen technologies, and in other implementations the inputs may be received through a keyboard, mouse, touchpad, or other input technologies, or any combination of these technologies.

In some embodiments, similar input/output devices may be separate from the computer system and may interact with one or more nodes of a distributed system that includes the computer system through a wired or wireless connection, such as over a network interface. The network interface may commonly support one or more wireless networking protocols (e.g., Wi-Fi/IEEE 802.11, or another wireless networking standard). The network interface may support communication via any suitable wired or wireless general data networks, such as other types of Ethernet networks, for example. Additionally, the network interface may support communication via telecommunications/telephony networks such as analog voice networks or digital fiber communications networks, via storage area networks such as Fibre Channel SANs, or via any other suitable type of network and/or protocol.

Any of the distributed system embodiments described herein, or any of their components, may be implemented as one or more network-based services in the cloud computing environment. For example, a read-write node and/or read-only nodes within the database tier of a database system may present database services and/or other types of data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format, such as the Web Services Description Language (WSDL). Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP). In some embodiments, network-based services may be implemented using Representational State Transfer (REST) techniques rather than message-based techniques. For example, a network-based service implemented according to a REST technique may be invoked through parameters included within an HTTP method such as PUT, GET, or DELETE.

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. When a grouping is used herein, all individual members of the group and all combinations and sub-combinations possible of the group are intended to be individually included in the disclosure. When a range is mentioned herein, the disclosure is specifically intended to include all points in that range and all sub-ranges within that range. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

1. A computerized system for tagging of a plurality of media properties, the system comprising:
a genomic database comprising a taxonomy consisting of a plurality of parameters, wherein each parameter in the plurality of parameters pertains to at least one media property in the plurality of media properties, and wherein a particular combination of the plurality of parameters may describe a feature of each of the plurality of media properties by tagging such media property from the plurality of media properties with the particular combination of the plurality of parameters;
a collaboration platform in communication with the genomic database, wherein the collaboration platform is configured to facilitate tagging of the plurality of media properties by a user with the particular combination of the plurality of parameters that describe the features of such media property from the plurality of media properties, the collaboration platform comprising:
a media coding tool, wherein the media coding tool is configured to present a user with a list of media properties from among the plurality of media properties for tagging and the taxonomy from the genetic database;
an image processing platform configured to automatically analyze each of the plurality of media properties by application of image processing and text processing techniques to return a parameter subset for each of the plurality of media properties, wherein each of the parameters of the parameter subset for each media property from among the plurality of media properties describes a feature of such media property from among the plurality of media properties;
a back-end system in communication with the collaboration platform, wherein the back-end system comprises:
a master database server controlling access to the genomic database;
a metadata database, wherein access to the metadata database is controlled by the master database server, and the metadata database comprising metadata for each of the plurality of media properties, wherein the metadata database is configured to be searchable from the media coding tool at the collaboration platform in order for the user using the media coding tool to be able to tag a media property from among the plurality of media properties;
a tenant and user database comprising a data set for each user from among a plurality of users, the data set indicative of each user from the plurality of users' privileges;
an ingress database configured to receive tagged media through the collaboration platform and store each of the properties from the plurality of media properties while users are tagging such media property from the plurality of media properties;
a golden master database in communication with the genomic database, wherein the genomic database comprises approved records for tagged media and wherein direct user access to the golden master database is blocked by access controls; and
an Identity and Authorization Management (IAM) service, wherein the IAM service is positioned in communication between the collaboration platform and the back-end system, and wherein the IAM service is configured to provide user identification, authentication, and authorization in order to control access to the back-end system through the collaboration platform by accessing user data at the tenant and user database.

2. The computerized system of claim 1, wherein the back-end system further comprises an application programming interface (API) configured to provide controlled access to the master database server at the back-end system.

3. The computerized system of claim 2, wherein the collaboration platform further comprises a quality assurance (QA) platform, wherein the QA platform is configured to calculate a quality score for a user who is tagging media properties from among the plurality of media properties at the collaboration platform and a coding quality score.

4. The computerized system of claim 3, wherein the collaboration platform further comprises a collaborative coding training platform configured to train users before such users tag media properties from among the plurality of media properties at the collaboration platform.

5. The computerized system of claim 1, wherein at least a portion of the plurality of media properties are part of a series of media properties, and wherein the genomic database comprises a plurality of individual media property parameters and a plurality of series media property parameters, wherein each of the plurality of series media property parameters describe a characteristic of the series of media properties rather than an individual media property within the series of media properties.

6. The computerized system of claim 1, wherein at least a portion of the plurality of media properties are part of a franchise of media properties, and wherein the genomic database further comprises a plurality of franchise media property parameters, wherein each of the plurality of franchise media property parameters describe a characteristic of the franchise of media properties rather than an individual media property within the franchise of media properties.

7. The computerized system of claim 1, wherein each of the plurality of parameters in the genomic database comprise a gene identifier (ID), a gene name, a category, a sub-category, and a sub-sub category.

8. The computerized system of claim 1, wherein the system is further configured to automatically roll up a parameter for an individual media property to either a series of media properties or a franchise of media properties to which the individual media property from among the plurality of media properties belongs.

9. The computerized system of claim 1, wherein the back-end system further comprises a first-party data database, wherein the first-party data database comprises behavioral data from a user, and the system is configured to apply behavioral data to a media property from among the plurality of media properties as the user is tagging the media property from among the plurality of media properties at the collaboration platform.

10. The computerized system of claim 1, wherein the back-end system comprises a plurality of first-party data databases, each of the first-party data databases accessible through the IAM service by only one user from a plurality of users.

11. The computerized system of claim 1, wherein the image processing platform comprises a plurality of image streaming services to each play at least one of the plurality of media properties, the image processing platform further in communication with the metadata database to apply metadata to each of the media properties from the plurality of media properties.

12. The computerized system of claim 11, wherein the image processing platform is further configured to produce, after processing the at least one of the plurality of media properties from the plurality of image streaming services, produce a genomic file and a parsed audio file that contain parameters derived from the at least one of the plurality of media properties.

13. The computerized system of claim 12, wherein the image processing platform is further configured to enter a set of image processing data from the genomic file and the parsed audio file into the genomic database.

14. A computer-implemented method for media tagging, the method comprising:
at a media selection tool, creating a media selection user interface (UI), wherein the media selection user interface comprises a plurality of titles each corresponding to one of a plurality of media properties;
after receiving a user selection in the media selection UI, creating a coding UI at a media coding tool for a selected media property, wherein the coding UI comprises a plurality of a genome parameters, wherein each genomic parameter in the plurality of genomic parameters pertains to at least one media property in the plurality of media properties;
receiving at the media coding tool a set of selected tags for the selected media property, creating a tagged media property data set, and storing the tagged media property data set at an ingress table in communication with a genomic database;
at an image processing platform, receiving from a plurality of image streaming services the plurality of media properties, applying metadata to the plurality of media properties, automatically producing a genomic file and a parsed audio file containing genomic parameters derived from the plurality of media properties, and writing a genomic data set from the genomic file and parsed audio file into the tagged media property data set in the ingress table in communication with the genomic database;
executing a quality assurance (QA) process against the tagged media property data set by comparing data in a golden master database with the tagged media property data set, and generating a coding quality score;
presenting a coding review UI to an analyst, and receiving an update to the tagged media property data set from the analyst; and
updating the golden master database with the tagged media property data set.

15. The method of claim 14, further comprising the step of limiting the plurality of titles for which the user accessing the media selection UI is authorized by view by means of an Identity and Authorization Management (IAM) service in communication with the media selection tool.

16. The method of claim 15, further comprising the step of, at the IAM service, accessing a tenant and user database to compare a set of user log-in inputs to a corresponding file in the tenant and user database to determine the plurality of titles that the user is authorized to view.

17. The method of claim 14, wherein the plurality of genomic parameters are divided into categories of genomic parameters, and each category of genomic parameter is divided into a sub-category of genomic parameters, and further comprising the step of displaying only a single category of genomic parameters or a single sub-category of genomic parameters at the coding UI.

18. The method of claim 14, further comprising the step of calculating a quality score for the user by comparing the set of selected tags for the selected media property to the golden master database, and measuring a mathematical distance between the set of selected tags for the selected media property and a corresponding data set in the golden master database.

19. The method of claim 14, further comprising the step of automatically rolling up a parameter for an individual media property to either a series of media properties or a franchise of media properties to which the selected media property belongs.

20. The method of claim 14, further comprising the steps of:
receiving behavioral data from a user;
storing the behavioral data in a user first-party database from among a plurality of first-party databases, wherein each of the plurality of first-party databases is specific to a particular user from a plurality of potential users and wherein no other user from among the plurality of potential users may access the user first-party database; and
applying the behavioral data from the user first-party database to the selected media property at the coding UI.
